(19) United States
(12) Patent Application Publication
(10) Pub. No.: US 2026/0046077 A1
(43) Pub. Date: Feb. 12, 2026

(54) METHODS AND APPARATUSES OF DETERMINING DOWNLINK CONTROL INFORMATION (DCI) FIELDS

(71) Applicant: LENOVO (BEIJING) LIMITED, Beijing (CN)

(72) Inventors: Lingling XIAO, Beijing (CN); Bingchao LIU, Beijing (CN); Chenxi ZHU, Fairfax, VA (US); Ruixiang MA, Beijing (CN); Wei LING, Beijing (CN); Yi ZHANG, Beijing (CN)

(21) Appl. No.: 18/851,391

(22) PCT Filed: Mar. 31, 2022
(86) PCT No.: PCT/CN2022/084358

§ 371 Date: Sep. 26, 2024

(51) Int. Cl. H04L 5/00; H04W 72/1268; H04W 72/232

(52) U.S. Cl. CPC H04L 5/001; H04W 72/1268; H04W 72/232

(57) ABSTRACT

Embodiments of the present disclosure relate to methods and apparatuses for determining downlink control information (DCI) fields. According to an embodiment of the present disclosure, a user equipment (UE) can include: a receiver configured to: receive DCI scheduling or activating a physical uplink shared channel (PUSCH) transmission, wherein the DCI also indicates a waveform of the PUSCH transmission scheduled or activated by the DCI; a processor coupled to the receiver and configured to: determine a bit width for each field of one or more fields in the DCI; and a transmitter coupled to the processor and configured to transmit the PUSCH transmission based on the DCI.

### TECHNICAL FIELD

Embodiments of the present disclosure are related to wireless communication technology, and more particularly, related to methods and apparatuses for determining DCI fields when dynamic waveform switching by DCI is supported for physical uplink shared channel (PUSCH) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may transmit data signals to a base station (BS) via a PUSCH. Various waveforms, including a discrete Fourier transform-spread orthogonal frequency division multiplexing (DFT-s-OFDM) waveform and a cyclic prefix orthogonal frequency division multiplexing (CP-OFDM) waveform, may be applied to a PUSCH transmission. Different waveforms may be advantageous in different scenarios. However, how to determine DCI fields to support DCI based dynamic switching between DFT-s-OFDM waveform and CP-OFDM waveform has not been discussed yet.

### SUMMARY

Embodiments of the present disclosure at least provide a technical solution of determining DCI fields when DCI based dynamic waveform switching is supported.

According to some embodiments of the present disclosure, a UE may include: a receiver configured to: receive DCI scheduling or activating a PUSCH transmission, wherein the DCI also indicates a waveform of the PUSCH transmission scheduled or activated by the DCI; a processor coupled to the receiver and configured to: determine a bit width for each field of one or more fields in the DCI; and a transmitter coupled to the processor and configured to transmit the PUSCH transmission based on the DCI.

In some embodiments of the present disclosure, the PUSCH transmission is one of: a dynamic PUSCH transmission scheduled by the DCI; a configured grant (CG) type 2 PUSCH transmission activated by the DCI; or a CG PUSCH retransmission scheduled by the DCI.

In some embodiments of the present disclosure, the bit width for each field of the one or more fields is determined to be a maximum bit width of bit widths determined based on RRC configurations for different waveforms of PUSCH transmissions respectively.

In some embodiments of the present disclosure, the one or more fields include a frequency domain resource allocation (FDRA) field, and the receiver is further configured to receive a first parameter configuring a first resource allocation type for CP-OFDM waveform and a second parameter configuring a second resource allocation type for DFT-s-OFDM waveform.

In some embodiments of the present disclosure, both the first resource allocation type and the second resource allocation type are resource allocation type 1, and the processor is further configured to determine a bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of an active bandwidth part (BWP).

In some embodiments of the present application, wherein the first resource allocation type is resource allocation type 0 and the second resource allocation type is resource allocation type 1, and the processor is further configured to determine a bit width of the FDRA field to be

$$max ( ⌈ {log}_{2} ( {N}_{RB}^{UL , BWP} ( {N}_{RB}^{UL , BWP} + 1 ) / 2 ) ⌉ , {N}_{RBG} ) bits ,$$

wherein

$${N}_{RB}^{UL , BWP}$$

is a size of an active bandwidth part (BWP), and N_{RBG} is a size of a resource block group.

In some embodiments of the present disclosure, the first resource allocation type is dynamic resource allocation and the second resource allocation type is resource allocation type 1, and the processor is further configured to determine a bit width of the FDRA field to be

$$max ( ⌈ {log}_{2} ( {N}_{RB}^{UL , BWP} ( {N}_{RB}^{UL , BWP} + 1 ) / 2 ) ⌉ , {N}_{RBG} ) + 1 bits ,$$

wherein

$${N}_{RB}^{UL , BWP}$$

is a size of an active BWP, and N_{RBG} is a size of a resource block group.

In some embodiments of the present disclosure, in the case that the FDRA field indicates the resource allocation type 0 for the PUSCH transmission, N_{RBG} least significant bits (LSBs) of the FDRA field are used to indicate a frequency resource allocation for the PUSCH transmission.

In some embodiments of the present disclosure, in the case that the FDRA field indicates the resource allocation type 1 and a frequency hopping is enabled for the waveform indicated by the DCI. N_{UL_hop} most significant bits (MSBs) of

$$⌈ {log}_{2} ( {N}_{RB}^{UL , BWP} ( {N}_{RB}^{UL , BWP} + 1 ) / 2 ) ⌉ LSBs$$

of the FDRA field are used to indicated a frequency offset and

$$⌈ {log}_{2} ( {N}_{RB}^{UL , BWP} ( {N}_{RB}^{UL , BWP} + 1 ) / 2 ) ⌉ - {N}_{UL \_ hop} LSBs$$

of the

$$⌈ {log}_{2} ( {N}_{RB}^{UL , BWP} ( {N}_{RB}^{UL , BWP} + 1 ) / 2 ) ⌉ LSBs$$

are used to indicate a frequency resource allocation for the PUSCH transmission, wherein N_{UL_hop} is determined according to a number of offset(s) included in a frequency hopping offset list.

In some embodiments of the present disclosure, in the case that the FDRA field indicates the resource allocation type 1 and a frequency hopping is disabled for the waveform indicated by the DCI,

$$⌈ {log}_{2} ( {N}_{RB}^{UL , BWP} ( {N}_{RB}^{UL , BWP} + 1 ) / 2 ) ⌉ LSBs$$

of the FDRA field are used to indicate a frequency resource allocation for the PUSCH transmission.

In some embodiments of the present disclosure, the one or more fields include a FDRA field, and the receiver is further configured to receive a parameter configuring a resource allocation type for CP-OFDM waveform and DFT-s-OFDM waveform.

In some embodiments of the present disclosure, the resource allocation type is resource allocation type 1, and the processor is further configured to determine a bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of an active BWP.

In some embodiments of the present disclosure, in the case that the resource allocation type is resource allocation type 0, and the processor is further configured to determine a bit width of the FDRA field to be N_{RBG} bits, wherein N_{RBG} is a size of a resource block group.

In some embodiments of the present disclosure, in the case that the waveform indicated by the DCI is the DFT-s-OFDM waveform and N<=N_{RBG}, the processor is further configured to determine N LSBs of the FDRA field to indicate a frequency resource allocation for the PUSCH transmission, wherein Nis a bit width of the FDRA field for the DFT-s-OFDM waveform determined based on resource allocation type 1.

In some embodiments of the present disclosure, in the case that the waveform is the DFT-s-OFDM waveform and N>N_{RBG}, the processor is further configured to determine N_{RBG} bits of the FDRA field to indicate a frequency resource allocation with a coarse granularity for the PUSCH transmission, wherein Nis a bit width of the FDRA field for the DFT-s-OFDM waveform determined based on resource allocation type 1.

In some embodiments of the present disclosure, the resource allocation type for the CP-OFDM waveform and the DFT-s-OFDM waveform is a dynamic resource allocation type.

In some embodiments of the present disclosure, the one or more fields include a frequency hopping flag field, and: in the case that frequency hopping is not configured for both a DFT-s-OFDM waveform and a CP-OFDM waveform in an active BWP, a bit width of the frequency hopping flag field is 0 bit; and in the case the frequency hopping is configured for at least one of the CP-OFDM waveform and the DFT-s-OFDM waveform in the active BWP, a bit width of the frequency hopping flag field is 1 bit.

In some embodiments of the present disclosure, in the case that the frequency hopping is not configured for the waveform indicated by the DCI and the bit width of the frequency hopping flag field is larger than 0 bit, the processor is configured to ignore the frequency hopping flag field; and in the case that the waveform indicated by the DCI is the CP-OFDM waveform and resource allocation type 0 is configured for the PUSCH transmission or indicated by the DCI, and the bit width of the frequency hopping flag field is larger than 0 bit, for the PUSCH transmission, the processor is configured to ignore the frequency hopping flag field.

In some embodiments of the present disclosure, the one or more fields include a sounding reference signal (SRS) resource indicator field, and the processor is further configured to determine a bit width for the SRS resource indicator field to be

$$⌈ {log}_{2} ( {\sum }_{k = 1}^{min ( {L}_{max} , {N}_{SRS} )} ( \begin{matrix}{N}_{SRS} \\ k\end{matrix} ) ) ⌉$$

for a non-codebook based PUSCH transmission, wherein N_{SRS} is a number of SRS resource in a SRS resource set configured for the PUSCH transmission and Lₘₐₓ is a maximum transmission layer configured to the UE for a serving cell; and in the case that the waveform indicated by the DCI is the DFT-s-OFDM waveform,

$$⌈ {log}_{2} ( {\sum }_{k = 1}^{min ( 1 , {N}_{SRS} )} ( \begin{matrix}{N}_{SRS} \\ k\end{matrix} ) ) ⌉ LSBs$$

are used for indicating SRS resource(s) in the SRS resource set for the non-codebook based PUSCH transmission.

In some embodiments of the present disclosure, the one or more fields include a second sounding reference signal (SRS) resource indicator field, and the processor is further configured to determine a bit width for the second SRS resource indicator field

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉$$

to be for a non-codebook based PUSCH transmission, wherein N_{SRS} is a number of SRS resource in another SRS resource set configured for the PUSCH transmission and Lₘₐₓ is a maximum transmission layer configured to the UE for a serving cell; and in the case that the waveform indicated by

$$⌈ {log}_{2} ( {max}_{k ∈ \{ 1 , 2 , … , min \{ 1 , {N}_{SRS} \} \}} ( \begin{matrix}{N}_{SRS} \\ k\end{matrix} ) ) ⌉ LSBs$$

the DCI is the DFT-s-OFDM waveform, are used for indicating SRS resource(s) in the another SRS resource set for the non-codebook based PUSCH transmission.

In some embodiments of the present disclosure, the one or more fields include a precoding information and number of layers field, and the processor is further configured to determine a bit width of the precoding information and number of layers field to be max{mₐ,m_{b}}, wherein mₐ is a bit width of precoding information and number of layers field determined according to configurations for a DFT-s-OFDM waveform and m_{b} is a bit width of precoding information and number of layers field determined according to configurations for a CP-OFDM waveform; and in the case that the waveform indicated by the DCI corresponds to a smaller value of mₐ and m_{b}, Ima-mal MSBs of the precoding information and number of layers field are padded with zeros.

In some embodiments of the present disclosure, the one or more fields include an antenna port field, and the processor is further configured to determine a bit width of the antenna port field to be max{xₐ, x_{b}}, wherein xₐ is a bit width of an antenna port field determined according to demodulation reference signal (DMRS) configuration for a DFT-s-OFDM waveform and x_{b} is a bit width of an antenna port field determined according to DMRS configuration for a CP-OFDM waveform; and in the case that the waveform indicated by the DCI corresponds to a smaller value of xₐ and x_{b}. |xₐ−x_{b}| MSBs of the antenna port field are padded with zeros.

In some embodiments of the present disclosure, the one or more fields include a phase tracking reference signal (PTRS)-DMRS association field, and the processor is further configured to determine a bit width of the PTRS-DMRS association field to be 2 bits in the case that a maximum layer configured for the PUSCH transmission is larger than 1; and in the case that the waveform indicated by the DCI is a DFT-s-OFDM waveform and the bit width of the PTRS-DMRS association field is larger than 0 bit, the processor is further configured to ignore the PTRS-DMRS association field.

In some embodiments of the present disclosure, the one or more fields include a second PTRS-DMRS association field, and the processor is further configured to determine a bit width of the second PTRS-DMRS association field to be 2 bits in the case that a maximum layer configured for the PUSCH transmission is larger than 2; in the case that the waveform indicated by the DCI is a DFT-s-OFDM waveform the bit width of the second PTRS-DMRS association field is larger than 0 bit, the processor is further configured to ignore the PTRS-DMRS association field.

In some embodiments of the present disclosure, the one or more fields include a beta_offset indicator field, and in the case that a beta_offset parameter is configured to be “semiStatic” for both a DFT-s-OFDM waveform and a CP-OFDM waveform, the processor is further configured to determine a bit width of the beta_offset indicator field to be 0 bit; in the case that a beta_offset parameter is configured to be “dynamic” for at least one of the CP-OFDM waveform or the DFT-s-OFDM waveform in an active BWP, the processor is further configured to determine a bit width of the beta_offset indicator field to be 2 bits; and in the case that a beta_offset parameter is configured to be “semiStatic” for the waveform indicated by the DCI and the bit width of the beta_offset indicator field is larger than 0 bit, the processor is further configured to ignore the beta_offset indicator field.

In some embodiments of the present disclosure, the one or more fields include a DMRS sequence initialization field, and the processor is further configured to determine a bit width of the DMRS sequence initialization field to be 1 bit; and in the case that the waveform indicated by the DCI is a DFT-s-OFDM waveform, the processor is further configured to ignore the DMRS sequence initialization field.

In some embodiments of the present disclosure, the processor is further configured to determine a bit width of each field of one or more fields based on configurations corresponding to the waveform indicated by the DCI, and the processor is further configured to determine a total bit width of the one or more fields to be max{Nₐ,N_{b}}, wherein Nₐ is a total bit width of the one or more fields determined according to configurations for a PUSCH transmission with a DFT-s-OFDM waveform and N_{b} is a total bit width of the one or more fields determined according to configurations for a PUSCH transmission with a CP-OFDM waveform; and in the case that the waveform indicated by the DCI corresponds to a smaller value of Nₐ and N_{b}, |Nₐ−N_{b}| zeros are padded before or after the one or more fields.

According to some other embodiments of the present disclosure, a BS may include: a processor and configured to: determine a bit width for each field of one or more fields in DCI for scheduling or activating a PUSCH transmission; a transmitter coupled to the processor and configured to: transmit the DCI, wherein the DCI indicates a waveform of the PUSCH transmission scheduled or activated by the DCI; and a receiver coupled to the processor and configured to: receive the PUSCH transmission based on the DCI.

In some embodiments of the present disclosure, the PUSCH transmission is one of: a dynamic PUSCH transmission scheduled by the DCI; a CG type 2 PUSCH transmission activated by the DCI; or a CG PUSCH retransmission scheduled by the DCI.

In some embodiments of the present disclosure, a bit width for each field of the one or one fields is determined to be a maximum bit width of bit widths determined based on RRC configurations for different waveforms of PUSCH transmissions respectively.

In some embodiments of the present disclosure, the one or more fields include a FDRA field, and the transmitter is further configured to transmit a first parameter configuring a first resource allocation type for CP-OFDM waveform and a second parameter configuring a second resource allocation type for DFT-s-OFDM waveform.

In some embodiments of the present disclosure, both the first resource allocation type and the second resource allocation type are resource allocation type 1, and the processor is further configured to determine a bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of BWP.

In some embodiments of the present disclosure, the first resource allocation type is resource allocation type 0 and the second resource allocation type is resource allocation type 1, and the processor is further configured to determine a bit width of the FDRA field to be

$$max ( ⌈ {log}_{2} ( {N}_{R B}^{UL , BWP} ( {N}_{RB}^{UL , BWP} + 1 ) / 2 ) ⌉ , {N}_{RBG} ) bits ,$$

wherein

$${N}_{RB}^{UL , BWP}$$

is a size of an active bandwidth part (BWP), and N_{RBG} is a size of a resource block group.

In some embodiments of the present disclosure, the first resource allocation type is dynamic resource allocation and the second resource allocation type is resource allocation type 1, and the processor is further configured to determine a bit width of the FDRA field to be

$$max ( ⌈ {log}_{2} ( {N}_{R B}^{UL , BWP} ( {N}_{RB}^{UL , BWP} + 1 ) / 2 ) ⌉ , {N}_{RBG} ) + 1 bits ,$$

wherein

$${N}_{RB}^{UL , BWP}$$

is a size of an active BWP, and N_{RBG} is a size of a resource block group.

In some embodiments of the present disclosure, in the case that the FDRA field indicates the resource allocation type 0 for the PUSCH transmission, N_{RBG} LSBs of the FDRA field are used to indicate a frequency resource allocation for the PUSCH transmission.

In some embodiments of the present disclosure, in the case that the FDRA field indicates the resource allocation type 1 and a frequency hopping is enabled for the waveform indicated by the DCI, N_{UL_hop} MSBs of

$$⌈ {log}_{2} ( {N}_{RB}^{UL , BWP} ( {N}_{RB}^{UL , BWP} + 1 ) / 2 ) ⌉ LSBs$$

of the FDRA field are used to indicate a frequency offset and

$$⌈ {log}_{2} ( {N}_{R B}^{UL , BWP} ( {N}_{R B}^{UL , BWP} + 1 ) / 2 ) ⌉ - {N}_{UL \_ hop} LSBs$$

of the

$$⌈ {log}_{2} ( {N}_{R B}^{UL , BWP} ( {N}_{R B}^{UL , BWP} + 1 ) / 2 ) ⌉ LSBs$$

are used to indicate a frequency resource allocation for the PUSCH transmission, wherein N_{UL_hop} is determined according to a number of offset(s) included in a frequency hopping offset list.

In some embodiments of the present disclosure, in the case that the FDRA field indicates the resource allocation type 1 and a frequency hopping is disabled for the waveform indicated in the DCI,

$$⌈ {log}_{2} ( {N}_{R B}^{UL , BWP} ( {N}_{R B}^{UL , BWP} + 1 ) / 2 ) ⌉ LSBs$$

of the FDRA field are used to indicate a frequency resource allocation for the PUSCH transmission.

In some embodiments of the present disclosure, the one or more fields include a FDRA field, and the transmitter is further configured to transmit one parameter configuring a resource allocation type for CP-OFDM waveform and DFT-s-OFDM waveform.

In some embodiments of the present disclosure, the resource allocation type is resource allocation type 1, and the processor is further configured to determine a bit width of the FDRA field to be

$$⌈ {log}_{2} ( {N}_{R B}^{UL , BWP} ( {N}_{R B}^{UL , BWP} + 1 ) / 2 ) ⌉ bits ,$$

wherein

$${N}_{R B}^{UL , BWP}$$

is a size of an active BWP.

In some embodiments of the present disclosure, in the case that the resource allocation type is resource allocation type 0, and the processor is further configured to determine a bit width of the FDRA field to be N_{RBG} bits, wherein N_{RBG} is a size of a resource block group.

In some embodiments of the present disclosure, in the case that the waveform indicated by the DCI is the DFT-s-OFDM waveform and N>N_{RBG}, the processor is further configured to determine N LSBs of the FDRA field to indicate a frequency resource allocation for the PUSCH transmission, wherein N is a bit width of the FDRA field for the DFT-s-OFDM waveform determined based on resource allocation type 1.

In some embodiments of the present disclosure, in the case that the waveform indicated by the DCI is the DFT-s-OFDM waveform and N>N_{RBG}, the processor is further configured to determine N_{RBG} bits of the FDRA field to indicate a frequency resource allocation with a coarse granularity for the PUSCH transmission, wherein N is a bit width of the FDRA field for the DFT-s-OFDM waveform determined based on resource allocation type 1.

In some embodiments of the present disclosure, the resource allocation type for the CP-OFDM waveform and the DFT-s-OFDM waveform is a dynamic resource allocation type.

In some embodiments of the present disclosure, the one or more fields include a frequency hopping flag field, and: in the case that frequency hopping is not configured for both a DFT-s-OFDM waveform and a CP-OFDM waveform in an active BWP, a bit width of the frequency hopping flag field is 0 bit; and in the case the frequency hopping is configured for at least one of the CP-OFDM waveform and the DFT-s-OFDM waveform in the active BWP, a bit width of the frequency hopping flag field is 1 bit.

In some embodiments of the present disclosure, the one or more fields include a sounding reference signal (SRS) resource indicator field, and the processor is further configured to determine a bit width for the SRS resource indicator field to be

$$⌈ {log}_{2} ( {\sum }_{k = 1}^{min ( {L}_{max} , {N}_{SRS} )} ( \begin{matrix}{N}_{SRS} \\ k\end{matrix} ) ) ⌉$$

for a non-codebook based PUSCH transmission, wherein N_{SRS} is a number of SRS resource in a SRS resource set configured for the PUSCH transmission and Lₘₐₓ is a maximum transmission layer configured to a UE for a serving cell; and wherein in the case that the waveform indicated by the DCI is the DFT-s-OFDM waveform,

$$⌈ {log}_{2} ( {\sum }_{k = 1}^{min ( 1 , {N}_{SRS} )} ( \begin{matrix}{N}_{SRS} \\ k\end{matrix} ) ) ⌉ LSBs$$

are used for indicating SRS resource(s) in the SRS resource set for the non-codebook based PUSCH transmission.

In some embodiments of the present disclosure, the one or more fields include a second sounding reference signal (SRS) resource indicator field, and the processor is further configured to determine a bit width for the second SRS resource indicator field to be

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉$$

for a non-codebook based PUSCH transmission, wherein N_{SRS} is a number of SRS resource in another SRS resource set configured for the PUSCH transmission and Lₘₐₓ is a maximum transmission layer configured to a UE for a serving cell; and in the case that the waveform indicated by the DCI is the DFT-s-OFDM waveform,

$$⌈ {log}_{2} ( {max}_{k ∈ \{ 1 , 2 , … , min \{ 1 , {N}_{SRS} \} \}} ( \begin{matrix}{N}_{SRS} \\ k\end{matrix} ) ) ⌉ LSBs$$

are used for indicating SRS resource(s) in the another SRS resource set for the non-codebook based PUSCH transmission.

In some embodiments of the present disclosure, the one or more fields include a precoding information and number of layers field, wherein the processor is further configured to determine a bit width of the precoding information and number of layers field to be max{mₐ,m_{b}}, wherein mₐ is a bit width of a precoding information and number of layers field derived according to configurations for a DFT-s-OFDM waveform and my is a bit width of precoding information and number of layers field determined according to configurations for a CP-OFDM; and in the case that the waveform indicated in the DCI corresponds to a smaller value of mₐ and m_{b}, |mₐ−m_{b}| MSBs of the precoding information and number of layers field are padded with zeros.

In some embodiments of the present disclosure, the one or more fields include an antenna port field, and the processor is further configured to determine a bit width of the antenna port field to be max{xₐ,x_{b}}, wherein xₐ is a bit width of an antenna port field determined according to DMRS configuration for a DFT-s-OFDM waveform and x_{b} is a bit width of an antenna port field determined according to DMRS configuration for a CP-OFDM waveform; and in the case that the waveform indicated in the DCI corresponds to a smaller value of xₐ and x_{b}, |xₐ−x_{b}| MSBs of the antenna port field are padded with zeros.

In some embodiments of the present disclosure, the one or more fields include a PTRS-DMRS association field, and the processor is further configured to determine a bit width of the PTRS-DMRS association field to be 2 bits in the case that a maximum layer configured for the PUSCH transmission is larger than 1.

In some embodiments of the present disclosure, the one or more fields include a second PTRS-DMRS association field, and the processor is further configured to determine a bit width of the second PTRS-DMRS association field to be 2 bits in the case that a maximum layer configured for the PUSCH transmission is larger than 2.

In some embodiments of the present disclosure, the one or more fields include a beta_offset indicator field, and: in the case that a beta_offset parameter is configured to be “semiStatic” for both a DFT-s-OFDM waveform and a CP-OFDM, the processor is further configured to determine a bit width of the beta_offset indicator field to be 0 bit; in the case that a beta_offset parameter is configured to be “dynamic” for at least one of the CP-OFDM waveform or the DFT-s-OFDM waveform in an active BWP, the processor is further configured to determine a bit width of the beta_offset indicator field to be 2 bits.

In some embodiments of the present disclosure, the one or more fields include a DMRS sequence initialization field, and the processor is further configured to determine a bit width of the DMRS sequence initialization field to be 1 bit.

In some embodiments of the present disclosure, the processor is further configured to determine a bit width of each field of one or more fields based on configurations corresponding to the waveform indicated by the DCI, and the processor is further configured to determine a total bit width of the one or more fields to be max{Nₐ,N_{b}}, wherein Nₐ is a total bit width of the one or more fields determined according to configurations for a PUSCH transmission with a DFT-s-OFDM waveform and N_{b} is a total bit width of the one or more fields determined according to configurations for a PUSCH transmission with a CP-OFDM waveform; and in the case that the waveform indicated by the DCI corresponds to a smaller value of Nₐ and N_{b}. |Nₐ−N_{b}| zeros are padded before or after the one or more fields.

According to some other embodiments of the present disclosure, a method performed by a UE may include: receiving DCI scheduling or activating a PUSCH transmission, wherein the DCI also indicates a waveform of the PUSCH transmission scheduled or activated by the DCI; and determining a bit width for each field of one or more fields in the DCI; and transmitting the PUSCH transmission based on the DCI.

According to some other embodiments of the present disclosure, a method performed by a BS may include: determining a bit width for each field of one or more fields in DCI for scheduling or activating a PUSCH transmission; transmitting the DCI, wherein the DCI indicates a waveform of the PUSCH transmission scheduled or activated by the DCI; and receiving the PUSCH transmission based on the DCI.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 is a flow chart illustrating an exemplary method for determining DCI fields according to some embodiments of the present disclosure;

FIG. 3 is a flow chart illustrating another exemplary method for determining DCI fields according to some other embodiments of the present disclosure; and

FIG. 4 illustrates a simplified block diagram of an exemplary apparatus for determining DCI fields according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

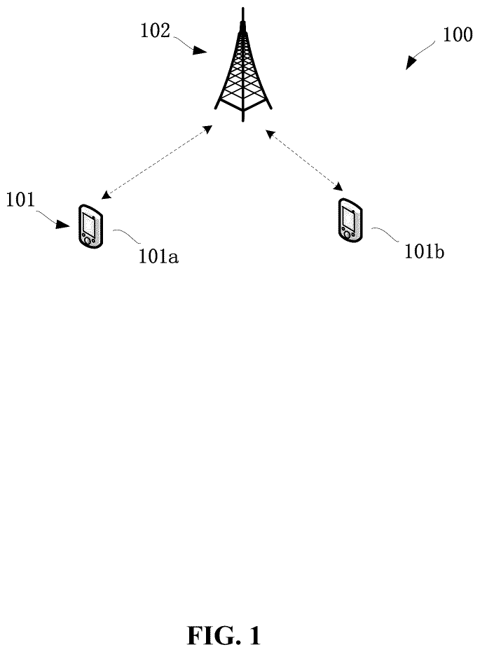

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A UE may transmit data signals to a BS via a PUSCH. A PUSCH transmission may be dynamically scheduled by a UL grant in a downlink control information (DCI), or may be transmitted based on a CG such as CG Type 1 or CG type 2 as specified in 3GPP standard documents. The CG Type 1 based PUSCH transmission may refer to that: a PUSCH transmission is semi-statically configured to operate in response to the reception of a higher layer parameter (e.g., the parameter configuredGrantConfig including rrc-ConfiguredUplinkGrant as specified in 3GPP standard documents) without the detection of a UL grant in a DCI. The CG Type 2 based PUSCH transmission may refer to that: a PUSCH transmission is semi-persistently scheduled by a UL grant in a valid activation DCI after the reception of a higher layer parameter (e.g., the parameter configuredGrantConfig not including rrc-ConfiguredUplinkGrant as specified in 3GPP standard documents).

Various waveforms, including but not be limited to DFT-s-OFDM waveform and CP-OFDM waveform, are supported in a PUSCH transmission(s) and may have their respective advantages in different scenarios. For example, for a PUSCH transmission with a DFT-s-OFDM waveform (e.g., the parameter transformPrecoder is enabled as specified in 3GPP standard documents), only one layer is supported while for a PUSCH transmission with a CP-OFDM waveform (e.g., the parameter transformPrecoder is disabled as specified in 3GPP standard documents), up to four layers can be supported. Moreover, compared with the CP-OFDM waveform, the peak to average power ratio (PAPR) of the DFT-s-OFDM waveform is relatively lower, and the efficiency of the power amplifier in a UE is higher.

In some embodiments of the present disclosure, a BS may semi-statically configure a waveform for a PUSCH transmission by higher layer (e.g., a layer higher than a physical layer) signaling. e.g., radio resource control (RRC) signaling. Switching between different waveforms by higher layer signaling is relatively slow.

It is agreed in 3GPP to study enhancements for dynamic switching between DFT-s-OFDM waveform and CP-OFDM waveform in Rel-18 coverage enhancement. The potential switching method may be implemented by a medium access control (MAC) control element (CE) message or by a DCI (e.g., DCI format 0_1 or a DCI format 0_2) indication. If a MAC-CE message is used for the dynamic waveform switching, the DCI fields in a DCI can be interpreted as legacy (e.g., according to the Rel-17 3GPP standard documents). That is because that: before receiving the DCI for scheduling or activating a PUSCH transmission, a UE may know the waveform and the corresponding configurations for the PUSCH transmission, and thus the bit width of each field in the DCI can be determined based on the configurations of the waveform.

However, for a DCI used for scheduling or activating a PUSCH transmission and also used for dynamic switching between DFT-s-OFDM waveform and CP-OFDM waveform, when a UE decodes the DCI, it does not know the waveform and the corresponding configurations of the PUSCH transmission. Thus, how to determine the bit widths of some fields and how to interpret these fields in the DCI for different waveforms needs to be solved.

Specifically, when a UE decodes a DCI, the UE needs to determine the bit width of each field in the DCI based on configurations for the scheduled PUSCH transmission. However, since different configurations may be configured for PUSCH transmission with different waveforms, e.g., DFT-s-OFDM (i.e., transformPrecoder is disabled) and CP-OFDM (i.e., transformPrecoder is enabled) in different scenarios, if the UE supports DCI based dynamic switching between DFT-s-OFDM waveform and CP-OFDM waveform, some fields in the DCI may have different bit widths for different waveforms based on different configurations. Then, how to determine the bit widths of these fields needs to be specified because the bit widths of DCI cannot change along with the different waveforms indicated by the DCI. In addition, these fields in the DCI may require different interpretations when different waveforms are indicated by the DCI.

Given the above, embodiments of the present disclosure propose solutions for determining DCI fields when DCI based dynamic waveform switching is supported. For example, embodiments of the present disclosure propose solutions for determining bit widths of some fields in a DCI when the DCI is used for dynamic waveform switching (e.g., dynamic switching between the DFT-s-OFDM waveform and CP-OFDM waveform), so as to ensure the bit widths of these fields can be correctly determined regardless of which waveform is indicated by the DCI, thereby supporting dynamic switching between DFT-s-OFDM waveform and CP-OFDM waveform. In addition, embodiments of the present disclosure also propose solutions for interpreting some fields when different waveform is indicated by the DCI. More details on the embodiments of the present disclosure will be illustrated in the following text in combination with the appended drawings.

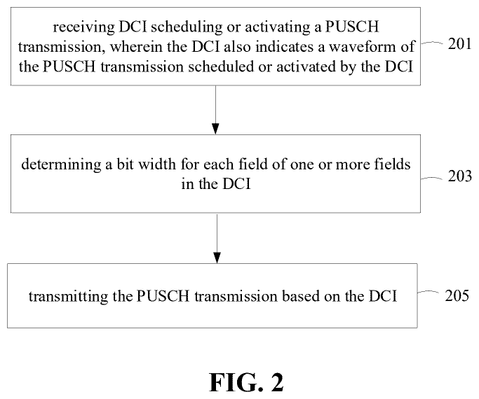

FIG. 2 is a flow chart illustrating an exemplary method 200 for determining DCI fields according to some embodiments of the present disclosure. The method in FIG. 2 may be implemented by a UE (e.g., UE 101 as shown in FIG. 1). Details described in all of the following detailed embodiments of the present disclosure are applicable for the embodiments shown in FIG. 2.

In the exemplary method shown in FIG. 2, in step 201, the UE may receive DCI from a BS (e.g., BS 102 in FIG. 1). The DCI may schedule or activate a PUSCH transmission. For example, the PUSCH transmission may be one of: a dynamic PUSCH transmission scheduled by the DCI; a CG type 2 PUSCH transmission activated by the DCI; or a CG PUSCH retransmission scheduled by the DCI. A CG PUSCH retransmission scheduled by the DCI means that a PUSCH retransmission is transmitted according to a CG configuration and is scheduled by a physical downlink control channel (PDCCH) with cyclic redundancy check (CRC) scrambled by configured scheduling radio network temporary identifier (CS-RNTI) with new data indicator (NDI)=1.

The DCI (e.g., a field in the DCI) may indicate a waveform of the PUSCH transmission scheduled or activated by the DCI. The waveform may be a DFT-s-OFDM waveform or a CP-OFDM waveform. In some embodiments of the present disclosure, the waveform of the PUSCH transmission may be indicated by whether the transform precoder is enabled or disabled. For example, in the case that the DCI indicates that the transform precoder is enabled, it means that the DCI indicates the DFT-s-OFDM waveform of the PUSCH transmission. In the case that the DCI indicates that the transform precoder is disabled, it means that the DCI indicates the CP-OFDM waveform of the PUSCH transmission.

In some embodiments of the present disclosure, the DCI may be a DCI format 0_1 or a DCI format 0_2.

After receiving the DCI, in step 203, the UE may determine a bit width for each field of one or more fields in the DCI. The one or more fields are DCI field(s) whose bit width(s) are determined by RRC parameter(s) that can be configured independently for DFT-s-OFDM waveform and CP-OFDM waveform. In other words, the one or more fields are field(s) that may have different bits widths for different waveforms. The following embodiments illustrate how to ensure the bit widths of the one or more fields being correctly determined regardless of which waveform is indicated by the DCI, thereby supporting dynamic switching between DFT-s-OFDM waveform and CP-OFDM waveform of the PUSCH transmission. In fact, in addition to the one or more fields in the DCI, the DCI may also include other field(s), and the UE may determine bit width for each field in the DCI. Since bit width(s) of the other field(s) may be the same for different waveforms, there is no issue when determine the other field(s) in the DCI and the UE may determine the bit width(s) of the other field(s) based on the methods as specified in 3GPP standard documents.

According to some embodiments of the present disclosure, the UE may determine the bit width for each field of the one or more fields to be the maximum bit width of bit widths determined (or derived) based on RRC configurations for different waveforms of PUSCH transmission respectively. For example, the UE may determine the bit width of each field to be the maximum bit width of bit widths determined (derived) based on RRC configurations for DFT-s-OFDM waveform and CP-OFDM waveform respectively.

In some embodiments of the present disclosure, the one or more fields may include a FDRA field. The FDRA field may indicate a frequency domain resource allocation for the PUSCH transmission. Specifically, there are three resource allocation types, e.g., resource allocation type 0, resource allocation type 1, and resource allocation type 2 specified in technical specification (TS) 38.214. For PUSCH transmission with DFT-s-OFDM waveform, resource allocation type 1 and resource allocation type 2 are supported; while for PUSCH transmission with CP-OFDM waveform, all the three resource allocation types are supported. Resource allocation type 0 (e.g., a parameter resourceAllocationType0 as specified in 3GPP standard documents), type 1 (e.g., a parameter resourceAllocationType1 as specified in 3GPP standard documents) or dynamic resource allocation (e.g., a parameter dynamicSwitch as specified in 3GPP standard documents, which means that DCI is used to further indicate the resource allocation type 0 or the resource allocation type 1 dynamically) can be configured in a PUSCH-config which is used to configure the UE specific PUSCH parameters applicable to a particular BWP.

In an embodiment of the present disclosure, before receiving the DCL the UE may receive different parameters configured to indicate resource allocation types for different waveforms. For example, the UE may receive a first parameter, e.g., resource AllocationforCP-OFDM (the candidate value can be resource allocation type 0, resource allocation type 1 or dynamic resource allocation) configuring a first resource allocation type for CP-OFDM waveform, and a second parameter, e.g., resourceAllocationforDET-s-OFDM (the candidate value can be resource allocation type 1) configuring a second resource allocation type for DFT-s-OFDM waveform. In such embodiments, “first resource allocation type” and “second resource allocation type” are only used to differentiate resource allocation types for different waveforms, and are different from “resource allocation type 1” and “resource allocation type 2” as stated above.

In some cases, both the first resource allocation type and the second resource allocation type are resource allocation type 1, i.e., only resource allocation type 1 is configured for both CP-OFDM waveform and DFT-s-OFDM waveform in an active BWP. The UE may determine a bit width of the FDRA field to be

$$⌈ {log}_{2} ( {N}_{R B}^{UL , BWP} ( {N}_{R B}^{UL , BWP} + 1 ) / 2 ) ⌉ bits ,$$

wherein

$${N}_{R B}^{UL , BWP}$$

is a size of the active BWP. In such cases, regardless of which waveform is indicated by the DCI, all

$$⌈ {log}_{2} ( {N}_{R B}^{UL , BWP} ( {N}_{R B}^{UL , BWP} + 1 ) / 2 ) ⌉ bits ,$$

may be used to indicate the frequency domain resource allocation for the UE.

In some other cases, the first resource allocation type may be resource allocation type 0 and the second resource allocation type may be resource allocation type 1. The UE may determine a bit width of the FDRA field to be

$$max ( ⌈ {log}_{2} ( {N}_{R B}^{UL , BWP} ( {N}_{R B}^{UL , BWP} + 1 ) / 2 ) ⌉ , {N}_{RBG} ) bits ,$$

wherein

$${N}_{R B}^{UL , BWP}$$

is a size of the active BWP, and N_{RBG} is a size of a resource block group as specified in TS 38.214. When the DCI indicates CP-OFDM used for the PUSCH transmission, the N_{RBG} LSB of the FDRA field may be used to indicate resource allocation type for the PUSCH transmission. When the DCI indicates DFT-s-OFDM used for the PUSCH transmission,

$$⌈ {log}_{2} ( {N}_{R B}^{UL , BWP} ( {N}_{R B}^{UL , BWP} + 1 ) / 2 ) ⌉ LSB$$

of the FDRA field may be used to indicate resource allocation type for the PUSCH transmission.

In some other cases, the first resource allocation type may be dynamic resource allocation and the second resource allocation type may be resource allocation type 1. The UE may determine a bit width of the FDRA field to be

$$max ( ⌈ {log}_{2} ( {N}_{R B}^{UL , BWP} ( {N}_{R B}^{UL , BWP} + 1 ) / 2 ) ⌉ , {N}_{RBG} ) + 1 bits ,$$

wherein

$${N}_{RB}^{UL , BWP}$$

is a size of the active BWP, and N_{RBG} is a size of a resource block group as specified in TS 38.214. The MSB of the FDRA field may be used to indicate resource allocation type 0 or resource allocation type 1 for the PUSCH transmission.

In such cases, the interpretations of remaining bits of the FDRA field may be different in different examples.

In some examples, in the case that the FDRA field (e.g., the MSB of the FDRA field) indicates the resource allocation type 0 for the PUSCH transmission, N_{RBG} LSBs of the FDRA field may be used to indicate a frequency resource allocation for the PUSCH transmission.

In some other examples, the FDRA field (e.g., the MSB of the FDRA field) may indicate the resource allocation type 1 for the PUSCH transmission. A PUSCH transmission with resource allocation type 1 can support frequency hopping. Accordingly, in such an example,

$$[ {log}_{2} ( {N}_{RB}^{UL , BWP} ( {N}_{RB}^{UL , BWP} + 1 ) / 2 ) ⌉ LSBs$$

of the FDRA field may indicate at least one of: a frequency offset or a frequency resource allocation.

For example, the BS may configure a frequency hopping for the PUSCH transmission with the waveform. In some embodiments, configure a frequency hopping for the PUSCH transmission with the waveform may refer to configuring a frequency hopping for a configured PUSCH repetition type (e.g., PUSCH repetition type A or PUSCH repetition type B as specified in TS 38.214). That is, configuring a frequency hopping for the PUSCH transmission may include one of the following cases: (1) configuring a dedicated RRC parameter which is used to configure frequency hopping for PUSCH repetition type A (e.g., a parameter frequency Hopping as specified in 3GPP standard documents) to the UE when PUSCH repetition type A (e.g., a parameter pusch-RepTypeA as specified in 3GPP standard documents) is configured for the PUSCH transmission; or (2) configuring another dedicated RRC parameter which is used to configure frequency hopping for PUSCH repetition type B (e.g., a parameter frequencyHoppingDCI-0-1-r16 as specified in 3GPP standard documents) to the UE when PUSCH repetition type B (e.g., a parameter pusch-RepTypeB as specified in 3GPP standard documents) is configured for the PUSCH transmission.

In the case that the frequency hopping is configured for the PUSCH transmission by the BS, whether the frequency hopping is enabled may be indicated by a frequency hopping flag field (illustrated below) in the DCI, and the frequency hopping being enabled or not may impact the

$$⌈ {log}_{2} ( {N}_{RB}^{UL , BWP} ( {N}_{RB}^{UL , BWP} + 1 ) / 2 ) ⌉ LSBs$$

of the FDRA field.

In an example, the FDRA field (e.g., the MSB of the FDRA field) indicates the resource allocation type 1 and the frequency hopping is enabled for the waveform. Then

$$⌈ {log}_{2} ( {N}_{RB}^{UL , BWP} ( {N}_{RB}^{UL , BWP} + 1 ) / 2 ) ⌉ LSBs$$

of the FDRA field may be used to indicate a frequency offset and a frequency resource allocation for the PUSCH transmission, wherein N_{UL_hop} MSBs of the

$$⌈ {log}_{2} ( {N}_{RB}^{UL , BWP} ( {N}_{RB}^{UL , BWP} + 1 ) / 2 ) ⌉ LSBs$$

are used to indicate a frequency offset and

$$⌈ {log}_{2} ( {N}_{RB}^{UL , BWP} ( {N}_{RB}^{UL , BWP} + 1 ) / 2 ) ⌉ - {N}_{UL \_ hop} LSBs$$

of the

$$⌈ {log}_{2} ( {N}_{RB}^{UL , BWP} ( {N}_{RB}^{UL , BWP} + 1 ) / 2 ) ⌉ LSBs$$

are used to indicate a frequency resource allocation for the PUSCH transmission, wherein N_{UL_hop} is determined according to a number of offset(s) included in a frequency hopping offset list (e.g., a parameter frequencyHoppingOffsetLists as specified in 3GPP standard documents).

In another example, the FDRA field (e.g., the MSB of the FDRA field) indicates the resource allocation type 1 for the PUSCH transmission and the frequency hopping may be disabled for the waveform, and

$$⌈ {log}_{2} ( {N}_{RB}^{UL , BWP} ( {N}_{RB}^{UL , BWP} + 1 ) / 2 ) ⌉ LSBs$$

of the FDRA field are used to indicate a frequency resource allocation for the PUSCH transmission.

In another embodiment of the present disclosure, before receiving the DCI, the UE may receive a parameter configured to indicate a resource allocation type for different waveforms. For example, the UE may receive a parameter, e.g., resourceAllocation configuring a resource allocation type for both the CP-OFDM waveform and DFT-s-OFDM waveform.

In some cases, only resource allocation type 1 can be configured when dynamic waveform switching is enabled. Specifically, since PUSCH transmission with DFT-s-OFDM waveform can only support resource allocation type 1, in such cases, the BS can only configure resource allocation type 1. That is, a UE expects resource allocation type 1 is configured if the UE supports DCI based dynamic switching between CP-OFDM waveform and DFT-s-OFDM waveform.

Accordingly, in such cases, the resource allocation type for CP-OFDM waveform and DFT-s-OFDM waveform is resource allocation type 1. The UE may determine a bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of the active BWP. In such cases, regardless of which waveform is indicated by the DCI, all

$$⌈ {log}_{2} ( {N}_{RB}^{UL , BWP} ( {N}_{RB}^{UL , BWP} + 1 ) / 2 ) ⌉ bits$$

may be used to indicate the frequency domain resource allocation for the UE.

In some other cases, the resource allocation type for CP-OFDM waveform and DFT-s-OFDM waveform may be resource allocation type 0, resource allocation type 1 or dynamic resource allocation type. In such cases, the bit width of the FDRA field may be the same as that determined based on a corresponding RRC configuration as specified in 3GPP standard documents, e.g., in 3GPP standard documents in Rel-15. However, the interpretation of the FDRA field may be different in some embodiments.

For example, in the case that the configured resource allocation type is resource allocation type 0, the bit width of the FDRA field is N_{RBG}, wherein N_{RBG} IS a size of a resource block group as specified in TS 38.214.

However, PUSCH transmission with DFT-s-OFDM waveform can only support resource allocation type 1. Thus, if DCI indicates DFT-s-OFDM waveform for the PUSCH transmission, the UE may still interpret the FDRA field based on resource allocation type 1.

Specifically, it is assumed that the bit width of the FDRA field determined for the DFT-s-OFDM waveform (i.e., determined based on resource allocation type 1) is N bits. In the case that the waveform indicated by the DCI is the DFT-s-OFDM waveform and N<=N_{RBG}, the UE may determine N LSBs of the FDRA field to indicate a frequency resource allocation for the PUSCH transmission.

In the case that the waveform indicated by the DCI is the DFT-s-OFDM waveform and N>N_{RBG}, the UE may determine N_{RBG} bits of the FDRA field to indicate a frequency resource allocation with a coarse granularity for the PUSCH transmission.

For example, the FDRA field includes a sequence of resource indication values (RIV), which corresponds to a starting resource block RBₛₜₐᵣₜ=0, K, 2·K . . . ,

$$( {N}_{BWP}^{RB} - 1 ) \cdot K$$

in a BWP. In such an example, a length is determined in terms of virtually contiguously allocated resource blocks L_{RBs}=K, 2·K,

$${N}_{BWP}^{RB} \cdot K .$$

wherein K is the maximum value from set {1, 2, 4, 8} which satisfies K≤└N/N_{RBG}┘.

In some other cases, only dynamic resource allocation type can be configured when dynamic waveform switching is enabled. That is, to support DCI based switching between CP-OFDM waveform and DFT-s-OFDM waveform, dynamic resource allocation type shall be configured because different waveforms support different resource allocation schemes.

Accordingly, in such cases, the resource allocation type configured for the CP-OFDM waveform and the DFT-s-OFDM waveform is a dynamic resource allocation type. The bit width and the interpretation of FDRA field in such cases may be the same as those specified in 3GPP standard documents, e.g., the bit width of FDRA field may be

$$max ( ⌈ {log}_{2} ( {N}_{RB}^{UL , BWP} ( {N}_{RB}^{UL , BWP} + 1 ) / 2 ) ⌉ , {N}_{RBG} ) + 1$$

as specified in 3GPP standard documents in Rel-15.

For example, it is assumed that field, e.g., 1-bit waveform indicator field, is added in DCI format 0_1 (or DCI format 0_2) for indicating the waveform of the PUSCH transmission being CP-OFDM waveform or DFT-s-OFDM waveform. For example, a value “0” of the waveform indicator field means that the PUSCH transmission is a PUSCH transmission with CP-OFDM waveform and a value “1” of the waveform indicator field means that the PUSCH transmission is a PUSCH transmission with DFT-s-OFDM waveform, and vice versa. In such embodiments, the FDRA field described in TS 38.214 may change. For example, passages marked with underline (addition) throughout the following sections illustrate changes to the FDRA field described in TS 38.214.
Frequency domain resource assignment:

$$⌈ {log}_{2} ( {N}_{RB}^{UL , BWP} ( {N}_{RB}^{UL , BWP} + 1 ) / 2 ) ⌉ bits$$

if resource allocation type 1 is configured for both CP-OFDM and DET-s-OEDM

$$max ( ⌈ {log}_{2} ( {N}_{RB}^{UL , BWP} ( {N}_{RB}^{UL , BWP} + 1 ) / 2 ⌉ , {N}_{RBG} ) + 1 bits$$

if resource allocation type of CP-OFDM is configured as type 0 and resource allocation type of DFT-s-OFDM is type 1.

$$max ( ⌈ {log}_{2} ( {N}_{RB}^{UL , BWP} ( {N}_{RB}^{UL , BWP} + 1 ) / 2 ⌉ , {N}_{RBG} ) + 1 bits$$

if resource allocation type of CP-OFDM is configured as dynamic and resource allocation type of DFT-s-OFDM is type 1. The MSB bit is used to indicate resource allocation type 0 or resource allocation type 1.

$${N}_{RB}^{UL , BWP}$$

For resource allocation type 1,

$$⌈ {log}_{2} ( {N}_{RB}^{UL , BWP} ( {N}_{RB}^{UL , BWP} + 1 ) / 2 ⌉ LSBs$$

provide the resource allocation. If frequency hopping is enabled for the indicated waveform, N_{UL_hop} MSB bits are used to indicate the frequency offset according to Clause 6.3 of [6. TS 38.214] and

$$⌈ {log}_{2} ( {N}_{RB}^{UL , BWP} ( {N}_{RB}^{UL , BWP} + 1 ) / 2 ⌉ - {N}_{UL\_hop} bits$$

provide the frequency domain resource allocation according to Clause 6.1.2.2.2 of [6. TS 38.214]. If frequency hopping is disabled for the indicated waveform.

$$⌈ {log}_{2} ( {N}_{RB}^{UL , BWP} ( {N}_{RB}^{UL , BWP} + 1 ) / 2 ⌉ bits$$

provide the frequency domain resource allocation according to Clause 6.1.2.2.2 of [6. TS 38.214]

In some other embodiments of the present disclosure, the one or more fields may include a frequency hopping flag field. This field may be used for indicating whether the frequency hopping is enabled or disabled for the PUSCH transmission. Specifically, a PUSCH transmission with resource allocation type 1 can support frequency hopping. For example, for a UE at a cell center, PUSCH transmission power is not an issue and the frequency hopping may be disabled to transmit PUSCH on more resources with a lower code rate; while for a cell-edge UE or a power limited UE, to increase coverage, the frequency hopping may be enabled for a PUSCH transmission.

In the case that the frequency hopping is not configured for both the DFT-s-OFDM waveform and the CP-OFDM waveform in an active BWP, a bit width of the frequency hopping flag field is 0 bit.

The frequency hopping being not configured for a waveform means that the frequency hopping is not configured for a configured PUSCH repetition type (e.g., PUSCH repetition type A or PUSCH repetition type B) of the PUSCH transmission with the waveform. For example, frequency hopping being not configured for a waveform includes one of: (1) a dedicated RRC parameter which is used to configure frequency hopping for PUSCH repetition type A (e.g., a parameter frequencyHopping as specified in 3GPP standard documents) is not configured to the UE when PUSCH repetition type A is configured for the PUSCH transmission; or (2) another dedicated RRC parameter which is used to configure frequency hopping for PUSCH repetition type B (e.g., a parameter frequencyHoppingDCI-0-1-r16 as specified in 3GPP standard documents) is not configured to the UE when PUSCH repetition type B is configured for the PUSCH transmission.

In the case that the frequency hopping is configured for at least one of the CP-OFDM waveform and DFT-s-OFDM waveform in the active BWP, a bit width of the frequency hopping flag field is 1 bit. Specifically, configuring a frequency hopping for the PUSCH transmission with the waveform may refer to configuring a frequency hopping for a configured PUSCH repetition type (e.g., PUSCH repetition type A or PUSCH repetition type B) as stated above.

In the case that a frequency hopping is not configured for the waveform indicated by the DCI and the bit width of the frequency hopping flag field is larger than 0 bit (e.g., 1 bit as stated above), the UE may ignore the frequency hopping flag field, that is, the field is not applicable for the PUSCH transmission.

In the case that the waveform indicated by the DCI is the CP-OFDM waveform and resource allocation type 0 is configured for the PUSCH transmission or indicated by the DCI for the PUSCH transmission and the bit width of the frequency hopping flag field is larger than 0 bit (e.g., 1 bit as stated above), the UE may ignore the frequency hopping flag field, that is, the field is not applicable for the PUSCH transmission.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the frequency hopping flag field described in TS 38.214 may change. For example, passages marked with underline (addition) throughout the following sections illustrate changes to the frequency hopping flag field described in TS 38.214.
Frequency hopping flag-0 or 1 bit:
   0 bit if the higher layer parameter frequencyHopping is not configured and the higher layer parameter pusch-RepTypeIndicatorForDCI-Format0-1 (which configures the PUSCH repetition type for a PUSCH transmission scheduled or activated by DCI format 0_1) is not configured to pusch-RepTypeB for both CP-OFDM and DET-s-OFDM, or if the higher layer parameter frequencyHoppingForDCI-Format0-1 is not configured and pusch-RepTypeIndicatorForDCI-Format0-1 is configured to pusch-RepTypeB for both CP-OFDM and DFT-s-OFDM, or if only resource allocation type 2 is configured;
   1 bit according to Table 7.3.1.1.1-3 otherwise, only applicable to resource allocation type 1, as defined in Clause 6.3 of [6. TS 38.214]. If the waveform is CP-OFDM and the resource allocation type configured for PUSCH transmission with CP-OFDM is type 0, or if the frequency hopping is not configured and RepTypeIndicatorForDCI-Format0-1 is not contoured to misch-RepTypeB for the indicated waveform, or if the higher layer parameter frequencyHoppingForDCI-Format0-1 not configured and pusch-RepTypeIndicatorForDCI-Format0-1 is configured to pusch-RepTypeB for the indicated waveform, the UE shall ignore this field.

In some other embodiments of the present disclosure, the one or more fields may include an SRS resource indicator field. This field is used to indicate the SRS resource(s) for the PUSCH transmission and also to indicate the number of layers for a non-codebook based PUSCH transmission.

In such embodiments, the UE may determine that a bit width for the SRS resource indicator field is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

for a non-codebook based PUSCH transmission, wherein N_{SRS} is a number of SRS resource in a SRS resource set configured for the PUSCH transmission (the SRS resource set is indicated by SRS resource set indicator field if it is present in the DCI, otherwise the SRS resource set is configured by higher layer parameter srs-ResourceSetToAddModList as in 3GPP standard documents and associated with the higher layer parameter usage of value ‘nonCodeBook’), and Lₘₐₓ is a maximum transmission layer configured to the UE for a serving cell. Specifically, Lₘₐₓ may be configured by maxMIMO-Layers as in 3GPP standard documents if UE supports operation with maxMIMO-Lavers and the higher layer parameter maxMIMO-Lavers is configured. Otherwise, Lₘₐₓ is given by the maximum number of layers for PUSCH supported by the UE for the serving cell for non-codebook based operation. For example, Lₘₐₓ is a maximum transmission layer supported by CP-OFDM waveform for dynamically switching between the CP-OFDM waveform and a DFT-s-OFDM waveform.

Then, in the case that the waveform indicated by the DCI is the DFT-s-OFDM waveform, since PUSCH transmission with DFT-s-OFDM can only support one layer,

$$⌈ {log}_{2} ( {\sum }_{k = 1}^{min ( 1 , {N}_{SRS} )} ( \begin{matrix}{N}_{SRS} \\ k\end{matrix} ) ) ⌉ {LSB}_{s}$$

of the SRS resource indicator field are used for indicating SRS resource(s) in the SRS resource set for the non-codebook based PUSCH transmission, that is, Lₘₐₓ is denoted as 1 when DFT-s-OFDM waveform is indicated in the DCI.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the SRS resource indicator field described in TS 38.214 may change. For example, passages marked with underline (addition) throughout the following sections illustrate changes to the SRS resource indicator field described in TS 38.214.
SRS resource indicator

$$⌈ {log}_{2} ( {\sum }_{k = 1}^{min ( {L}_{max} , {N}_{SRS} )} ( \begin{matrix}{N}_{SRS} \\ k\end{matrix} ) ) ⌉ or ⌈ {log}_{2} ( {N}_{SRS} ) ⌉ bits ,$$

where N_{SRS} is the number of configured SRS resources in the SRS resource set configured by higher layer parameter srs-ResourceSetToAddModList (which configures a list of SRS resource set for a PUSCH transmission in the active BWP), and associated with the higher layer parameter usage of value ‘codeBook’ or ‘nonCodeBook’,

$$⌈ {log}_{2} ( {\sum }_{k = 1}^{min ( {L}_{max} , {N}_{SRS} )} ( \begin{matrix}{N}_{SRS} \\ k\end{matrix} ) ) ⌉ bits$$

according to Tables 7.3.1.1.2-28/29/30/31 if the higher layer parameter txConfig=nonCodebook, where N_{SRS} is the number of configured SRS resources in the SRS resource set configured by higher layer parameter srs-ResourceSetToAddModList. and associated with the higher layer parameter usage of value ‘nonCodeBook and
if UE supports operation with maxMIMO-Layers (which indicates the maximum MIMO layer to be used for PUSCH in all BWPs of the normal UL of this serving cell) and the higher layer parameter maxMIMO-Layers of PUSCH-ServingCellConfig of the serving cell is configured, Lₘₐₓ is given by that parameter
otherwise, Lₘₐₓ is given by the maximum number of layers for PUSCH supported by the UE for the serving cell for non-codebook based operation. For DCI indicating PUSCH transmission with DFT-s-OFDM, the

$$⌈ {log}_{2} ( {\sum }_{k = 1}^{min ( 1 , {N}_{SRS} )} ( \begin{matrix}{N}_{SRS} \\ k\end{matrix} ) ) ⌉ LSB$$

used for indicating SRS resource(s).

In some other embodiments of the present disclosure, the one or more fields may include a second SRS resource indicator field. This field is used to indicate the SRS resource(s) which is introduced in 3GPP Rel-17 to support a PUSCH repetition transmission to multiple transmit-receive points (M-TRPs).

In such embodiments, the UE may determine that a bit width for the second SRS resource indicator field is

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉$$

for non-codebook based PUSCH transmission, wherein N_{SRS} is a number of SRS resource in another SRS resource set configured for the PUSCH transmission (the another SRS resource set is the second SRS resource set configured by higher layer parameter srs-ResourceSetToAddModList as in 3GPP standard documents and associated with the higher layer parameter usage of value ‘nonCodeBook’)) and Lₘₐₓ is a maximum transmission layer configured to the UE for a serving cell. Specifically, Lₘₐₓ may be configured by maxMIMO-Layers as in 3GPP standard documents if UE supports operation with maxMIMO-Lovers and the higher layer parameter maxMIMO-Layers is configured. Otherwise, Lₘₐₓ is given by the maximum number of layers for PUSCH supported by the UE for the serving cell for non-codebook based operation. For example, Lₘₐₓ is a maximum transmission layer supported by CP-OFDM waveform for dynamically switching between the CP-OFDM waveform and a DFT-s-OFDM waveform.

Then, in the case that the waveform is the DFT-s-OFDM waveform, since PUSCH transmission with DFT-s-OFDM can only support one layer,

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉ LSBs$$

are used for indicating SRS resource(s) in the another SRS resource set for the PUSCH transmission, that is, Lₘₐₓ is denoted as 1 when DFT-s-OFDM waveform is indicated in the DCI.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the second SRS resource indicator field described in TS 38.214 may change. For example, passages marked with underline (addition) throughout the following sections illustrate changes to the second SRS resource indicator field described in TS 38.214.
Second SRS resource indicator-0.

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉ or ⌈ {log}_{2} ( {N}_{SRS} ) ⌉ bits ,$$

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉ bits$$

according to Tables 7.3.1.1.2-28/29A/30A/31A with the same number of layers indicated by SRS resource indicator field if the higher layer parameter txConfig=nonCodebook and SRS resource set indicator field is present, where N_{SRS} is the number of configured SRS resources in the second SRS resource set, and
if UE supports operation with maxMIMO-Layers and the higher layer parameter maxMIMO-Layers of PUSCH-ServingCellConfig of the serving cell is configured, Lₘₐₓ is given by that parameter
otherwise, Lₘₐₓ is given by the maximum number of layers for PUSCH supported by the UE for the serving cell for non-codebook based operation. For DCI indicating PUSCH transmission with DET-s-OFDM, the

$$⌈ {log}_{2} ( {\sum }_{k = 1}^{min ( 1 , {N}_{SRS} )} ( \begin{matrix}{N}_{SRS} \\ k\end{matrix} ) ) ⌉$$

LSB used for indicating SRS resource(s).

In some other embodiments of the present disclosure, the one or more fields include a precoding information and number of layers field. The field may be used to indicate the transmission layer for a codebook based PUSCH transmission and to indicate the precoder matrix for the PUSCH transmission. In some embodiments of the present disclosure, the precoding information and number of layers field herein may refer to a first precoding information and number of layers field as specified in 3GPP standard documents or a second precoding information and number of layers field as specified in 3GPP standard documents.

The UE may determine a bit width of the precoding information and number of layers field to be max{mₐ,m_{b}}, mₐ is a bit width of a precoding information and number of layers field which is derived (or determined) according to configurations for a DFT-s-OFDM waveform as specified in 3GPP standard documents. For example, mₐ may be determined based on at least one of the following configurations configured for DFT-s-OFDM waveform: txConfig as specified in 3GPP standard documents (which configures either codebook or non-codebook based PUSCH for the active BWP), full power transmission mode, the number of antenna ports, or maximum transmission layers of PUSCH transmission. m_{b} is a bit width of a precoding information and number of layers field which is derived (or determined) according to configurations for a CP-OFDM waveform as specified in 3GPP standard documents. For example, m_{b} may be determined based on at least one of the following configurations configured for CP-OFDM waveform: txConfig as specified in 3GPP standard documents (which configures either codebook or non-codebook based PUSCH for the active BWP), full power transmission mode, the number of antenna ports, or maximum transmission layers of PUSCH transmission. In some other embodiments of the present application, mₐ is a bit width of a precoding information and number of layers field which is derived (or determined) according to configurations for a CP-OFDM waveform as specified in 3GPP standard documents and my is a bit width of a precoding information and number of layers field which is derived (or determined) according to configurations for a DFT-s-OFDM waveform as specified in 3GPP standard documents.

In the case that the waveform indicated by the DCI corresponds to a smaller value of mₐ and m_{b}, |mₐ−m_{b}| MSBs of the precoding information and number of layers field are padded with zeros, and the remaining bits of the precoding information and number of layers field are used to indicate the transmission layer for a codebook based PUSCH transmission and to indicate the precoder matrix for the PUSCH transmission.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the precoding information and number of layers field described in TS 38.214 may change. For example, passages marked with underline (addition) throughout the following sections illustrate changes to the precoding information and number of layers field described in TS 38.214.
Precoding information and number of layers—number of bits determined by the following:
   0 bits if the higher layer parameter txConfig=nonCodeBook;
   0 bits for 1 antenna port and if the higher layer parameter txConfig=codebook;
   4, 5, or 6 bits according to Table 7.3.1.1.2-2 for 4 antenna ports, If the indicated waveform is CP-OFDM and if txConfig=codebook, ul-FullPowerTransmission (which is used to configure the full power transmission mode) is not configured for CP-OFDM or configured to fullpowerMode2 or configured to fullpower for CP-OFDM, and according to the values of higher layer parameters maxRank (which is used to configure the maximum transmission layers of a PUSCH transmission in the active BWP), and codebookSubset (which is used to configure the precoder matrix subset for a PUSCH transmission in the active BWP);
   4 or 5 bits according to Table 7.3.1.1.2-2A for 4 antenna ports. If the indicated waveform is CP-OFDM and if txConfig=codebook, ul-FullPowerTransmission=fullpowerMode1 for CP-OFDM, maxRank=2, and according to the values of higher layer parameter codebookSubset;
   4 or 6 bits according to Table 7.3.1.1.2-2B for 4 antenna ports, If the indicated waveform is CP-OFDM and if txConfig=codebook, ul-FullPowerTransmission=fullpower Model for CP-OFDM, maxRank=3 or 4, and according to the values of higher layer parameter codebookSubset,
   2, 4, or 5 bits according to Table 7.3.1.1.2-3 for 4 antenna ports, If the indicated waveform is CP-OFDM and maxRank=1 or the indicated waveform is DET-s-OFDM and if txConfig=codebook, ul-FullPowerTransmission is not configured for the indicated waveform or configured to fullpowerMode2 or configured to fullpower for the indicated waveform and according to codebookSubset;
   3 or 4 bits according to Table 7.3.1.1.2-3A for 4 antenna ports, if txConfig=codebook, and the indicated waveform is CP-OFDM and ul-FullPowerTransmission=fullpowerMode1, maxRank=1 for CP-OFDM, or if the indicated waveform is DFT-s-OFDM and ul-FullPowerTransmission=fullpower Model for DFT-s-OFDM and according to the values of higher layer parameter codebookSubset,
   2 or 4 bits according to Table 7.3.1.1.2-4 for 2 antenna ports, If the indicated waveform is CP-OFDM and if txConfig=codebook, ul-FullPowerTransmission is not configured for CP-OFDM or configured to fullpowerMode2 or configured to fullpower for CP-OFDM, and according to the values of higher layer parameters maxRank and codebookSubset.
   2 bits according to Table 7.3.1.1.2-4A for 2 antenna ports. If the indicated waveform is CP-OFDM and if txConfig=codebook, ul-FullPowerTransmission=fullpowerMode1 for CP-OFDM, maxRank=2, and codebook Subset=nonCoherent;
   1 or 3 bits according to Table 7.3.1.1.2-5 for 2 antenna ports. If the indicated waveform is CP-OFDM and maxRank=1 or the indicated waveform is DFT-s-OFDM and if txConfig=codebook, ul-FullPowerTransmission is not configured for the indicated waveform of configured to fullpowerMode2 or configured to fullpower for the indicated waveform and according to the values of higher layer parameters maxRank and codebookSubset.
   2 bits according to Table 7.3.1.1.2-5A for 2 antenna ports, if txConfig=codebook, and if the indicated waveform is CP-OFDM and ul-FullPowerTransmission=fullpowerMode1, maxRank=1 for CP-OFDM, or if the indicated waveform is DFT-s-OFDM and ul-FullPowerTransmission=fullpowerMode1 for DET-s-OFDM, and according to the values of higher layer parameter codebookSubset;
If full power transmission is configured for both CP-OFDM and DFT-s-OFDM, same full power control mode shall be expected for the two UL waveforms.
If transform precoder is enabled and if a UE support dynamic switching DFT-s-OFDM and CP-OFDM based on a DCI, the bit width of this field equals maxim, max{mₐ,m_{b}}, where mₐ is the bit width of this field derived according to configuration for PUSCH transmission with DFT-s-OFDM and m_{b} is the bit with derived according to configuration for PUSCH transmission with CP-OFDM. A number of |mₐ-m_{b}| zeros are padded in the MSB of this field, if the indicated waveform corresponds to the smaller value of mₐ and m_{b}.
Same rule is also applied for the second Precoding information and number of layers field if it is present in the scheduling DCI

In some other embodiments of the present disclosure, the one or more fields include an antenna port field. This field is used to indicate the DMRS port of the PUSCH transmission.

The UE may determine a bit width of the antenna port field to be max{xₐ, x_{b}}. xₐ is a bit width of an antenna port field determined according to DMRS configuration for a DFT-s-OFDM waveform as specified in 3GPP standard documents. In some embodiments, xₐ may also be determined based on a rank of the PUSCH transmission (e.g., a transmission layer of the PUSCH transmission) indicated by the DCI. For example, the DMRS configuration may include at least one of: DMRS type (which configures the DMRS pattern in frequency domain) and the maximum length of DMRS (which means DMRS occupies one consecutive symbol in time domain). x_{b} is a bit width of an antenna port field determined according to DMRS configuration for a CP-OFDM waveform as specified in 3GPP standard documents. For example, the DMRS configuration may include at least one of: DMRS type (which configures the DMRS pattern in frequency domain) and the maximum length of DMRS (which means DMRS occupies one consecutive symbol in time domain). In some embodiments, x_{b} may also be determined based on a rank of the PUSCH transmission (e.g., a transmission layer of the PUSCH transmission) indicated by the DCI. In some other embodiments of the present application, xₐ is a bit width of an antenna port field determined according to DMRS configuration for a CP-OFDM waveform as specified in 3GPP standard documents and x_{b} is a bit width of an antenna port field determined according to DMRS configuration for a DFT-s-OFDM waveform as specified in 3GPP standard documents.

DMRS configuration for the CP-OFDM waveform and DMRS configuration for the DFT-s-OFDM waveform may be the same or different.

In the case that the waveform indicated by the DCI corresponds to a smaller value of xₐ and x_{b}, |xₐ−x_{b}| MSBs of the antenna port field are padded with zeros, and the remaining bits of the antenna port field are used to indicate the DMRS port of the PUSCH transmission.

For example, it is assumed that one PUSCH-config IE (which is used to configure parameters used for a PUSCH transmission) is configured in a BWP and a same RRC parameter is used for configuring DMRS configuration for both the DFT-s-OFDM waveform and CP-OFDM waveform. Moreover, it is assumed that the DMRS type included in the DMRS configuration is type 1 (which configures the DMRS pattern in the frequency domain) and the maximum length of DMRS included in the DMRS configuration is one (which means that DMRS occupies one consecutive symbol in the time domain). Furthermore, it is also assumed that a DCI schedules a codebook based PUSCH transmission and the maximum number of layer of the PUSCH transmission is 1 (i.e., Lₘₐₓ=1) and tp-pi2BPSK (which configures whether pi/2 BPSK modulation is used or not for a PUSCH transmission with DFT-s-OFDM waveform) is not configured to the UE.

Then, based on following Table 1, the UE may determine that xₐ is 2 bits. Specifically, Table 1 may be the same as Table 7.3.1.1.2-6 in TS 38.212, which defines the DMRS antenna port(s) for DFT-s-OFDM waveform under the above DMRS configuration. For Table 1, transform precoder is enabled, dmrs-Type=1, maxLength=1, except that dmrs-UplinkTransformPrecoding-r16 and tp-pi2BPSK are both configured and π/2-BPSK modulation is used

TABLE 1

| | Number of DMRS | |
|---|---|---|
| | CDM group(s) | DMRS |
| Value | without data | port(s) |
| 0 | 2 | 0 |
| 1 | 2 | 1 |
| 2 | 2 | 2 |
| 3 | 2 | 3 |

Based on following Table 2, the UE may determine that x_{b} is 3 bits. Specifically, Table 2 may be the same as Table 7.3.1.1.2-8 in TS 38.212, which defines the DMRS antenna port(s) for CP-OFDM waveform under the above DMRS configuration and rank=1. For Table 2, transform precoder is disabled, dmrs-Type=1, maxLength=1, rank=1.

TABLE 2

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Given the above, the bit width of antenna ports field in the DCI is 3 bits. If the DCI indicates DFT-s-OFDM waveform, 2 LSB bits of the field indicates the antenna ports for the PUSCH transmission according to Table 1. If the DCI indicates CP-OFDM waveform, 3 bits of the field indicates the antenna ports for the PUSCH transmission according to Table 2.

In another example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the antenna port field described in TS 38.214 may change. For example, passages marked with underline (addition) throughout the following sections illustrate changes to the antenna port field described in TS 38.214.
Antenna ports—number of bits determined by the following
   2 bits as defined by Tables 7.3.1.1.2-6. If the indicated waveform is DFT-s-OFDM and if dmrs-Type=1, and maxLength=1 wherein maxLength is used to configure the DMRS for a PUSCH transmission is single-symbol of double-symbol, except that dmrs-UplinkTransformPrecoding-r16 (which configures DMRS for Rel-16 DFT-s-OFDM based PUSCH transmission) and tp-pi2BPSK (which configures whether Pi/2 BPSK modulation is enabled or not) are both configured and π/2 BPSK modulation is used;
   2 bits as defined by Tables 7.3.1.1.2-6A, If the indicated waveform is DFT-s-OFDM and if dmrs-UplinkTransformPrecoding-r16 and ip-pi2BPSK are both configured, π/2 BPSK modulation is used, dmrs-Type=1, and maxLength=1, where n_{SCID} is the scrambling identity for antenna ports defined in [Clause 6.4.1.1.1.2, TS38.211];
   4 bits as defined by Tables 7.3.1.1.2-7, if the indicated waveform is DFT-s-OFDM, dmrs-Type=1, and maxLength=2, except that dmrs-UplinkTransformPrecoding-r16 and tp-pi2BPSK are both configured and π/2 BPSK modulation is used;
   4 bits as defined by Tables 7.3.1.1.2-7A, if the indicated waveform is DET-s-OFDM and dmrs-UplinkTransformPrecoding-r16 and tp-pi2BPSK are both configured, π/2 BPSK modulation is used, dmrs-Type=1, and maxLength=2, where n_{SCID} is the scrambling identity for antenna ports defined in [Clause 6.4.1.1.1.2, TS38.211];
   3 bits as defined by Tables 7.3.1.1.2-8/9/10/11, if the indicated waveform is CP-OFDM, dmrs-Type=1, and maxLength=1, and the value of rank is determined according to the SRS resource indicator field if the higher layer parameter txConfig=nonCodebook and according to the Precoding information and number of layers field if the higher layer parameter txConfig=codebook;
   4 bits as defined by Tables 7.3.1.1.2-12/13/14/15, if the indicated waveform is CP-OFDM, dmrs-Type=1, and maxLength=2, and the value of rank is determined according to the SRS resource indicator field if the higher layer parameter txConfig=nonCodebook and according to the Precoding information and number of layers field if the higher layer parameter txConfig=codebook;
   4 bits as defined by Tables 7.3.1.1.2-16/17/18/19, if the indicated waveform is CP-OFDM, dmrs-Type=2, and maxLength=1, and the value of rank is determined according to the SRS resource indicator field if the higher layer parameter txConfig=nonCodebook and according to the Precoding information and number of layers field if the higher layer parameter txConfig=codebook.
   5 bits as defined by Tables 7.3.1.1.2-20/21/22/23, if the indicated waveform is CP-OFDM, dmrs-Type=2, and maxLength=2, and the value of rank is determined according to the SRS resource indicator field if the higher layer parameter txConfig=nonCodebook and according to the Precoding information and number of layers field if the higher layer parameter txConfig=codebook.
If transform precoder is enabled and if a UE support dynamic switching DFT-s-OFDM and CP-OFDM based on a DCI, the bit width of this field equals max{xₐ, x_{b}}, where xₐ is the “Antenna ports” bit width derived according to DMRS configuration for PUSCH transmission with DFT-s-OFDM and x_{b} is the “Antenna ports” bit width derived according to DMRS configuration for PUSCH transmission with CP-OFDM by legacy rule. A number of |xₐ−x_{b}| zeros are padded in the MSB of this field, if the indicated waveform corresponds to the smaller value of xₐ and x_{b}. The interpretation of xₐ or x_{b} bits of this field is same as legacy.

In some other embodiments of the present disclosure, the one or more fields include a PTRS-DMRS association field. This field may be used to indicate the association between a PTRS port and a DMRS port for the scheduled or activated PUSCH transmission. For a PUSCH transmission with DFT-s-OFDM waveform, since the maximum layer of the PUSCH transmission is one, this field is 0 bit. However, for a PUSCH transmission with CP-OFDM and the maximum layer of PUSCH transmission is more than one, 2 bits may be used for indicating the association between PTRS port and DMRS port.

Given the above, to support dynamic switching between DFT-s-OFDM waveform and CP-OFDM waveform, the UE may determine a bit width of the PTRS-DMRS association field to be 2 bits in the case that a maximum layer configured for the PUSCH transmission is larger than 1.

In some embodiments, in the case that the waveform indicated by the DCI is the DFT-s-OFDM waveform and the PTRS-DMRS association field is more than 0 bit (i.e., 2 bits), the UE may ignore the PTRS-DMRS association field, that is, the PTRS-DMRS association field is only applicable for CP-OFDM waveform.

In some other embodiments of the present disclosure, the one or more fields include a second PTRS-DMRS association field. This field may be used to indicate the association between a PTRS port and a DMRS port for PUSCH transmission to M-TRP with CP-OFDM waveform.

Accordingly, for the second PTRS-DMRS association field, the UE may determine a bit width of the second PTRS-DMRS association field to be 2 bits in the case that a maximum layer configured for the PUSCH transmission is larger than 2. In the case that the waveform indicated by the DCI is the DFT-s-OFDM waveform and the second PTRS-DMRS association field is more than 0 bit (i.e., 2 bits), the UE may ignore the PTRS-DMRS association field, that is, the second PTRS-DMRS association field is only applicable for CP-OFDM waveform.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the PTRS-DMRS association field and potentially the second PTRS-DMRS association field described in TS 38.214 may change. For example, passages marked with underline (addition) throughout the following sections illustrate changes to the PTRS-DMRS association field and potentially the second PTRS-DMRS association field described in TS 38.214.
PTRS-DMRS association—number of bits determined as follows
   0 bit if PTRS-UplinkConfig is not configured in either dmrs-UplinkForPUSCH-MappingTypeA or dmrs-UplinkForPUSCH-MappingTypeB for CP-OFDM, or if maxRank=1;
   2 bits otherwise, where Table 7.3.1.1.2-25 and 7.3.1.1.2-26 are used to indicate the association between PTRS port(s) and DMRS port(s) for transmission of one PT-RS port and two PT-RS ports respectively for CP-OFDM, and the DMRS ports are indicated by the Antenna ports field. If the indicated waveform is DFT-s-OFDM, the UE shall ignore this field.
   If second PT-RS association field is present in the scheduling DCI, it is only applied for PUSCH transmission with CP-OFDM. For PUSCH transmission with DET-s-OFDM, UE will ignore this field.

In some other embodiments of the present disclosure, the one or more fields include a beta_offset indicator field. The field is for indicating a beta-offset used for calculating the number of resource elements (REs) when uplink control information (UCI) is multiplexed on a PUSCH transmission. Generally, the total resources of a PUSCH transmission with CP-OFDM waveform are more than the total resources of a PUSCH transmission with DFT-s-OFDM waveform because the CP-OFDM waveform can support more PUSCH transmission layers. Given this, different beta_offset parameters or the same beta_offset parameter may be configured for CP-OFDM waveform and DFT-s-OFDM waveform.

For example, in the case that a beta_offset parameter is configured to be “semiStatic” (which means the value of beta_offset can only be changed by RRC reconfiguration) for both the DFT-s-OFDM waveform and the CP-OFDM waveform, the UE may determine a bit width of the beta_offset indicator field to be 0 bit.

In another example, in the case that a beta_offset parameter is configured to be “dynamic” (which means the value of beta_offset can also be changed by the DCI) for at least one of the CP-OFDM waveform or the DFT-s-OFDM waveform in an active BWP, the UE may determine a bit width of the beta_offset indicator field to be 2 bits.

In yet another example, in the case that a beta_offset parameter is configured to be “semiStatic” for the waveform indicated by the DCI and the bit width of the beta_offset indicator field is larger than 0 bit, the UE may ignore the beta_offset indicator field, that is, the beta_offset indicator field is only applicable for the waveform for which the beta_offset parameter is configured to be “semiStatic”.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the beta_offset indicator field described in TS 38.214 may change. For example, passages marked with underline (addition) throughout the following sections illustrate changes to the beta_offset indicator field described in TS 38.214.
beta_offset indicator−0 if the higher layer parameter betaOffsets=semiStatic for both CP-OFDM and DET-s-OFDM: otherwise 2 bits as defined by Table 9.3-3 in [5. TS 38.213]. If the betaOffsets=semiStatic for the indicated waveform and for the other configured waveform betaOffsets is set as dynamic, the UE shall ignore this field for the waveform with betaOffsets of semiStatic.

In some other embodiments of the present disclosure, the one or more fields include a DMRS sequence initialization field. The field is 1 bit to indicate one of the two DMRS scrambling identifies (IDs) for CP-OFDM waveform only. Given this, to support dynamic switching between DFT-s-OFDM waveform and CP-OFDM waveform, the UE may determine a bit width of the DMRS sequence initialization field to be 1 bit.

Then, in the case that the waveform indicated by the DCI is the DFT-s-OFDM waveform, the UE may ignore the DMRS sequence initialization field, that is, the DMRS sequence initialization field is only appliable for CP-OFDM waveform.

For example, as stated above, it is assumed that a field, e.g., 1-bit waveform indicator field, is added in DCI format 0_1 (or DCI format 0_2) for indicating the waveform of the PUSCH transmission being CP-OFDM waveform or DFT-s-OFDM waveform. In such embodiments, the DMRS sequence initialization field described in TS 38.214 may change. For example, passages marked with underline (addition) throughout the following sections illustrate changes to the DMRS sequence initialization field described in TS 38.214.
DMRS sequence initialization −1 bit. If the indicated waveform is DET-s-OFDM, the UE shall ignore this field

Table 3 in the following provides an example regarding how to determine bit widths for some fields in the DCI and how to interpret these fields when different waveform is indicated in the DCI.

TABLE 3

| | Bit width | Interpretation of the field in DCI | |
|---|---|---|---|
| Fields in DCI | of the | DCI indicates | DCI indicates |
| format 0_1/0_2 | field | CP-OFDM | DFT-s-OFDM |
| Frequency | 1 | UE ignore this field | According to Table |
| hopping flag | | | 7.3.1.1.1-3 specified |
| | | | in TS38.212 |
| SRS resource | 4 | According to Table | 2 LSB is used for |
| indicator | | 7.3.1.1.2-31 in TS | SRS resource |
| | | 38.212 | indication and |
| | | | interpretation is |
| | | | according to Table |
| | | | 7.3.1.1.2-28 in TS |
| | | | 38.212 |
| Antenna ports | 5 | According to Table | 4 LSB is used for |
| | | 7.3.1.1.2-21 in TS | antenna port |
| | | 38.212(suppose | indication and |
| | | indicated rank = | interpretation is |
| | | 2 by SRS resource | according to Table |
| | | indicator field) | 7.3.1.1.2-7 in TS |
| | | | 38.212 |
| PTRS-DMRS | 2 | According to Table | UE ignores this field |
| association | | 7.3.1.1.2-25/26 in | |
| | | TS 38.212 | |
| beta_offset | 2 | According to Table | UE ignores this field |
| indicator | | 9.3-3 in TS 38.213 | |
| DMRS sequence | 1 | Use legacy rule | UE ignores this field |
| initialization | | | |

Specifically, Table 3 may be determined based on the following assumptions:
two PUSCH-config IEs (e.g., PUSCH-config #1 and PUSCH-config #2) are configured in a BWP of a cell. In PUSCH-config #1, a parameter transformPrecoder is disabled, which means that PUSCH-config #1 is used for configuring parameters for a PUSCH transmission with CP-OFDM waveform (i.e., PUSCH-config #1 is used for configuring parameters for CP-OFDM waveform). In PUSCH-config #2, a parameter transformPrecoder is enabled, which means that PUSCH-config #2 is used for configuring parameters for a PUSCH transmission with DFT-s-OFDM waveform (i.e., PUSCH-config #2 is used for configuring parameters for DFT-s-OFDM waveform).
One field, e.g., 1-bit waveform indicator field, is added in a DCI (e.g., DCI format 0_1 or DCI format 0_2) for indicating the waveform of a PUSCH transmission being CP-OFDM waveform or DFT-s-OFDM waveform.
The resource allocation type in PUSCH-config #1 for CP-OFDM waveform is dynamic resource allocation. The resource allocation type in PUSCH-config #2 for DFT-s-OFDM waveform is type 1 resource allocation.
PUSCH repetition type A is configured for PUSCH transmission with both CP-OFDM waveform and DFT-s-OFDM waveform. Frequency hopping is configured for DFT-s-OFDM waveform but is not configured for CP-OFDM.
Beta_offset is configured to be “dynamic” for CP-OFDM waveform and is configured to be “semiStatic” for DFT-s-OFDM waveform.
One SRS resource set with four SRS resources for non-codebook PUSCH transmission in configured in the active BWP and the DCI schedules a non-codebook based PUSCH transmission
DMRS type being type 1 and the maximum length being 2 are configured DFT-s-OFDM waveform while DMRS type being type 2 and the maximum length being 2 are configured for CP-OFDM. The maximum number of layers supported by the UE is four.

Based on the above assumptions, the UE may determine bit widths for some fields and interpreting these fields as shown in Table 3.

For example, since frequency hopping is configured for DFT-s-OFDM waveform but is not configured for CP-OFDM waveform, the UE may determine the bit width of the frequency hopping flag field is 1 bit. In the case that the DCI indicates CP-OFDM waveform, the UE ignores this field. In the case that the DCI indicates DFT-s-OFDM waveform, the UE may use the 1 bit to determine whether the frequency hopping is enabled or disabled according to Table 7.3.1.1.1-3 specified in TS 38.212.

Since one SRS resource set with four SRS resources for non-codebook PUSCH transmission in configured in the active BWP and the maximum number of layers is four, the UE may determine the bit width of the SRS resource indicator field to be

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ = 4 bits$$

(wherein, N_{SRS}=4 and Lₘₐₓ=4). In the case that the DCI indicates CP-OFDM waveform, the UE may determine that these 4 bits are used to indicate the SRS resource(s) for the PUSCH transmission according to Table 7.3.1.1.2-31 in TS 38.212. In the case that the DCI indicates DFT-s-OFDM waveform, the UE may determine that

$${log}_{2} ( {\sum }_{k = 1}^{min ( 1 , {N}_{SRS} )} ( \begin{matrix}{N}_{SRS} \\ k\end{matrix} ) ) = 2 LSBs$$

of the 4 bits are used to indicate the SRS resource(s) for the PUSCH transmission according to Table 7.3.1.1.2-28 in TS 38.212.

Based on the DMRS configuration (e.g., DMRS type being type 1 and the maximum length being 2) configured DFT-s-OFDM waveform, the UE may determine that a bit width of the antenna port field for the DFT-s-OFDM waveform is 4 bits according to Table 7.3.1.1.2-7 in TS 38.212. Based on the DMRS configuration (e.g., DMRS type being type 2 and the maximum length being 2) configured CP-OFDM waveform and assuming that the rank indicated by the SRS resource indicator field is 2, the UE may determine that a bit width of the antenna port field for the CP-OFDM waveform is 5 bits according to 7.3.1.1.2-21 in TS 38.212. Accordingly, the bit width of the antenna port field in the DCI will be 5 bits for supporting dynamic switching between DFT-s-OFDM waveform and CP-OFDM waveform.

In the case that the DCI indicates CP-OFDM waveform, the UE may determine that the 5 bits are used for indicating the DMRS antenna port(s) according to Table 7.3.1.1.2-21 in TS 38.212. In the case that the DCI indicates DFT-s-OFDM waveform, the UE may determine that the 4 LSBs of the 5 bits are used for indicating the DMRS antenna port(s) according to Table 7.3.1.1.2-7 in TS 38.212.

Since the maximum number of layers supported by the UE is four, the UE may determine a bit width of the PTRS-DMRS association field to be 2 bits. Then, in the case that the DCI indicates CP-OFDM waveform, the UE may determine that these 2 bits are used for indicating the association between a PTRS port and DMRS port DMRS antenna port(s) according to 7.3.1.1.2-25/26 in TS 38.212. In the case that the DCI indicates DFT-s-OFDM waveform, the UE may ignore this field.

Since Beta_offset is configured to be “dynamic” for CP-OFDM waveform and is configured to be “semiStatic” for DFT-s-OFDM waveform, the UE may determine a bit width of the Beta_offset field to be 2 bits. Then, in the case that the DCI indicates CP-OFDM waveform, the UE may determine that these 2 bits are used for indicating the beta_offset according to Table 9.3-3 in TS 38.213. In the case that the DCI indicates DFT-s-OFDM waveform, the UE may ignore this field.

The UE may determine a bit width of the DMRS sequence initialization field to be 1 bit to support dynamic switching between the CP-OFDM waveform and the DFT-s-OFDM waveform. In the case that the DCI indicates CP-OFDM waveform, the UE may use the 1 bit to determine the DMRS scrambling ID based on the methods as specified in 3GPP standard. In the case that the DCI indicates DFT-s-OFDM waveform, the UE may ignore this field.

In the above embodiments, in order to ensure the bit width of each field being correctly determined regardless of which waveform is indicated by the DCI, the UE may determine the bit width for each field to be a maximum bit width of bit widths determined based on RRC configurations for different waveforms of PUSCH transmission respectively.

However, according to some other embodiments of the present disclosure, the bit width of each field of the one or more fields may be determined according to the RRC configurations corresponding to each waveform as specified in 3GPP standard documents (e.g., based on the same methods as specified in 3GPP standard documents in Rel-15), but the total bit widths of the one or more fields which correspond to different RRC configurations for different waveforms, shall be aligned for different waveforms since the DCI size cannot change along with the different indicated waveform.

In such embodiments, for each field of the one or more fields, the UE may determine a bit width of each field based on the configurations corresponding to the waveform indicated by the DCI. The UE may also determine a total bit width of the one or more fields to be max{Nₐ,N_{b}}, wherein Nₐ is a total bit width of the one or more fields determined according to configurations for a PUSCH transmission with the DFT-s-OFDM waveform and N_{b} is a total bit width of the one or more fields determined according to configurations for a PUSCH transmission with the CP-OFDM waveform. In some other embodiments of the present application, Nₐ is a total bit width of the one or more fields determined according to configurations for a PUSCH transmission with the CP-OFDM waveform and N_{b} is a total bit width of the one or more fields determined according to configurations for a PUSCH transmission with the DFT-s-OFDM waveform.

In the case that the waveform indicated by the DCI corresponds to a smaller value of Nₐ and N_{b}. |Nₐ−N_{b}| zeros are padded before or after the one or more fields.

Table 4 in the following provides an example regarding how to determine a total bit width of some fields bit. Specifically, Table 4 may be determined based on the same assumptions as those for Table 3.

TABLE 4

| | Bit width of the field in DCI | |
|---|---|---|
| Fields in DCI | DCI indicates | DCI indicates |
| format 0_1/0_2 | CP-OFDM | DFT-s-OFDM |
| Frequency | 0 | 1 bit and interpret |
| hopping flag | | according to Table |
| | | 7.3.1.1.1-3 specified in |
| | | TS38.212 |
| SRS resource | 4 bits and interpret | 2 bits and interpret |
| indicator | according to Table | according to Table |
| | 7.3.1.1.2-31 in | 7.3.1.1.2-28 in |
| | TS 38.212 | TS 38.212 |
| Antenna ports | 5 bits and interpret | 4 bits and interpret |
| | according to Table | according to Table |
| | 7.3.1.1.2-21 in TS | 7.3.1.1.2-7 in TS 38.212 |
| | 38.212(suppose indicated | |
| | rank = 2 by SRS resource | |
| | indicator field) | |
| PTRS-DMRS | 2 bits and interpret | 0 |
| association | according to Table | |
| | 7.3.1.1.2-25/26 in | |
| | TS 38.212 | |
| beta_offset | 2 bits and interpret | 0 |
| indicator | according to Table 9.3-3 in | |
| | TS 38.213 | |
| DMRS sequence | 1 | 0 |
| initialization | | |
| Padding bits | 0 | 7 |

Referring to Table 4, for the frequency hopping field, in the case that the DCI indicates CP-OFDM waveform, this field is 0 bit. In the case that the DCI indicates DFT-s-OFDM waveform, this field is 1 bit and the UE may use the 1 bit to determine whether the frequency hopping is enabled or disabled according to Table 7.3.1.1.1-3 specified in TS 38.212.

For the SRS resource indicator field, in the case that the DCI indicates CP-OFDM waveform, the UE may determine that a bit width of this field is 4 bits and determine that the 4 bits are used to indicate the SRS resource(s) for the PUSCH transmission according to Table 7.3.1.1.2-31 in TS 38.212. In the case that the DCI indicates DFT-s-OFDM waveform, the UE may determine that a bit width of this field is 2 bits and determine that the 2 bits are used to indicate the SRS resource(s) for the PUSCH transmission according to Table 7.3.1.1.2-28 in TS 38.212.

For the antenna port field, in the case that the DCI indicates CP-OFDM waveform, the UE may determine that a bit width of this field is 5 bits and determine that the 5 bits are used for indicating the DMRS antenna port(s) according to Table 7.3.1.1.2-21 in TS 38.212. In the case that the DCI indicates DFT-s-OFDM waveform, the UE may determine that a bit width of this field is 4 bits and determine that the 4 bits are used for indicating the DMRS antenna port(s) according to Table 7.3.1.1.2-7 in TS 38.212.

For the PTRS-DMRS association field, in the case that the DCI indicates CP-OFDM waveform, the UE may determine a bit width of this field is 2 bits and determine that the 2 bits are used for indicating the association between a PTRS port and DMRS port DMRS antenna port(s) according to 7.3.1.1.2-25/26 in TS 38.212. In the case that the DCI indicates DFT-s-OFDM waveform, the UE may determine a bit width of this field is 0 bit.

For the Beta_offset field, in the case that the DCI indicates CP-OFDM waveform, the UE may determine a bit width of this field is 2 bits and determine that the 2 bits are used for indicating the beta_offset according to Table 9.3-3 in TS 38.213. In the case that the DCI indicates DFT-s-OFDM waveform, the UE may determine a bit width of this field is 0 bit.

For the DMRS sequence initialization field, in the case that the DCI indicates CP-OFDM waveform, the UE may determine a bit width of this field is 1 bit and determine that the 1 bit is used for indicating the DMRS scrambling ID based on the methods as specified in 3GPP standard. In the case that the DCI indicates DFT-s-OFDM waveform, the UE may determine a bit width of this field is 0 bit.

Given the above, a total bit width (e.g., Nₐ) of the one or more fields determined according to the configurations for a PUSCH transmission with the DFT-s-OFDM waveform is 7 bits and a total bit width (e.g., N_{b}) of the one or more fields determined according to configurations for a PUSCH transmission with the CP-OFDM waveform is 14 bits. Accordingly, the UE may determine that a total bit width of the one or more fields to be 14 bits. In the case that the DCI indicates the DFT-s-OFDM waveform, 7 zeros may be after the DMRS sequence initialization field.

After determining a bit width for each field of one or more fields in the DCI, in step 205, the UE may transmit the PUSCH transmission based on the DCI.

Although the above examples in FIG. 2 fake DCI forma 0_1 as an example, the same principles and methods may also be applicable for DCI forma 0_2. When the DCI in FIG. 2 is DCI format 0_2, the higher layer parameters configured for the DCI format 0_1 may be changed to the higher layer parameters configured for DCI forma 0_2. For example, the parameter frequencyHoppingDCI-0-1-r16 which is used to configure frequency hopping for PUSCH repetition type B for DCI forma 0_1 may be changed to a parameter frequencyHoppingDCI-0-2-r16 as specified in 3GPP standard documents.

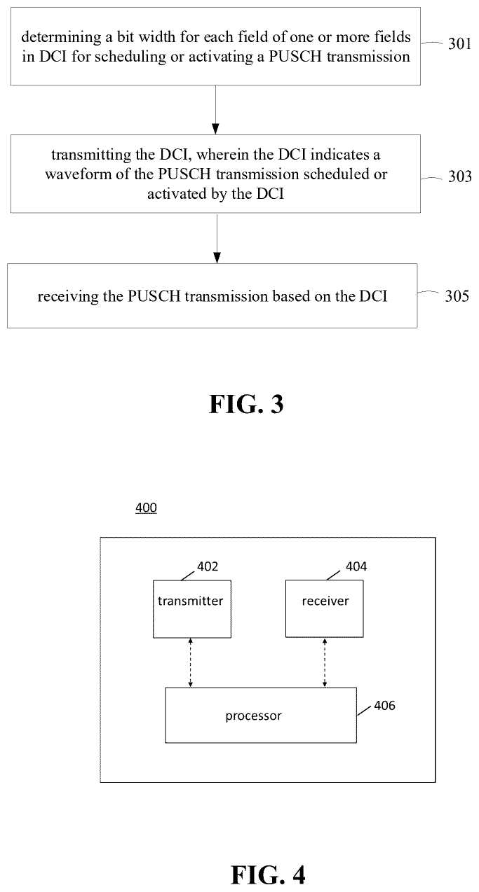

FIG. 3 is a flow chart illustrating an exemplary method 300 for determining DCI fields according to some other embodiments of the present disclosure. The method in FIG. 3 may be implemented by a BS (e.g., BS 102 as shown in FIG. 1). Details described in all of the following detailed of the present disclosure are applicable for the embodiments shown in FIG. 3.

In the exemplary method shown in FIG. 3, in step 301, the BS may determine a bit width for each field of one or more fields in a DCI for scheduling or activating a PUSCH transmission from a UE (e.g., the UE 101a or UE 101b as shown in FIG. 1). The PUSCH transmission may be one of: a dynamic PUSCH transmission scheduled by the DCI; a CG type 2 PUSCH transmission activated by the DCI; or a CG PUSCH retransmission scheduled by the DCI.

The one or more fields are DCI field(s) whose bit width(s) are determined by RRC parameter(s) that can be configured independently for DFT-s-OFDM waveform and CP-OFDM waveform. In other words, the one or more fields are field(s) that may have different bits widths for different waveforms. In the embodiments of FIG. 3, the BS may use the same methods as those used in the embodiments of FIG. 2 by the UE to determine a bit width for each field of one or more fields in a DCI.

In fact, in addition to the one or more fields in the DCI, the DCI may also include other field(s), and the BS may determine bit width for each field in the DCI. For example, the DCI (e.g., a field in the DCI) may indicate a waveform of the PUSCH transmission scheduled or activated by the DCI. Since bit width(s) of the other field(s) are not changed for different waveforms, the BS may determine the bit width(s) of the other field(s) based on the methods as specified in 3GPP standard documents.

In some embodiments of the present disclosure, the DCI may be a DCI format 0_1 or a DCI format 0_2.

According to some embodiments of the present disclosure, the BS may determine the bit width for each field of the one or more fields to be the maximum bit width of bit widths determined (or derived) based on RRC configurations for different waveforms of PUSCH transmission respectively. For example, the BS may determine the bit width for each field to be the maximum bit width of bit widths determined (or derived) based on RRC configurations for DFT-s-OFDM waveform and CP-OFDM waveform respectively.

In some embodiments of the present disclosure, the one or more fields may include a FDRA field. The FDRA field may indicate a frequency domain resource allocation for the PUSCH transmission. Specifically, there are three resource allocation types, e.g., resource allocation type 0, resource allocation type 1, and resource allocation type 2 specified in TS 38.214. For PUSCH transmission with DFT-s-OFDM waveform, resource allocation type 1 and resource allocation type 2 are supported; while for PUSCH transmission with CP-OFDM waveform, all the three resource allocation types are supported. Resource allocation type 0, allocation type 1 or dynamic allocation type may be configured in a PUSCH-config which is used to configure the UE specific PUSCH parameters applicable to a particular BWP.

In an embodiment of the present disclosure, before transmitting the DCI, the BS may transmit different parameters to indicate resource allocation types for different waveforms. For example, the BS may transmit a first parameter e.g., resourceAllocationforCP-OFDM configuring a first resource allocation type for CP-OFDM waveform and a second parameter, e.g., resourceAllocationforDFT-s-OFDM configuring a second resource allocation type for DFT-s-OFDM waveform.

In some cases, both the first resource allocation type and the second resource allocation type are resource allocation type 1, i.e., only resource allocation type 1 is configured for both CP-OFDM waveform and DFT-s-OFDM waveform in an active BWP. Then, the BS may determine the bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of the active BWP. In such cases, regardless of which waveform is indicated by the DCI, all

$$⌈ {log}_{2} ( {N}_{RB}^{UL , BWP} ( {N}_{RB}^{UL , BWP} + 1 ) / 2 ) ⌉ bits$$

may be used to indicate the frequency domain resource allocation for the UE.

In some other cases, the first resource allocation type may be resource allocation type 0 and the second resource allocation type may be resource allocation type 1. The UE may determine a bit width of the FDRA field to be

$$max ( ⌈ {log}_{2} ( {N}_{RB}^{UL , BWP} ( {N}_{RB}^{UL , BWP} + 1 ) / 2 ) ⌉ , {N}_{RBG} ) bits ,$$

wherein

$${N}_{RB}^{UL , BWP}$$

is a size of the active BWP, and N_{RBG} is a size of a resource block group as specified in TS 38.214. When the DCI indicates CP-OFDM used for the PUSCH transmission, the N_{RBG} LSB of the FDRA field may be used to indicate resource allocation type for the PUSCH transmission. When the DCI indicates DFT-s-OFDM used for the PUSCH transmission, the

$$⌈ {log}_{2} ( {N}_{RB}^{UL , BWP} ( {N}_{RB}^{UL , BWP} + 1 ) / 2 ) ⌉ LSB$$

of the FDRA field may be used to indicate resource allocation type for the PUSCH transmission.

In some other cases, the first resource allocation type may be dynamic resource allocation and the second resource allocation type may be resource allocation type 1.

The BS may determine a bit width of the FDRA field to be

$$max ( ⌈ {log}_{2} ( {N}_{RB}^{UL , BWP} ( {N}_{RB}^{UL , BWP} + 1 ) / 2 ) ⌉ , {N}_{RBG} ) + 1 bits ,$$

wherein

$${N}_{RB}^{UL , BWP}$$

is a size of the active BWP, and N_{RBG} is a size of a resource block group as specified in TS 38.214. The MSB of the FDRA field may be used to indicate resource allocation type 0 or resource allocation type 1 for the PUSCH transmission.

In such cases, the interpretations of remaining bits of the FDRA field may be different in different examples.

In some examples, in the case that the FDRA field (e.g., the MSB of the FDRA field) indicates the resource allocation type 0 for the PUSCH transmission, N_{RBG} LSBs of the FDRA field may be used to indicate a frequency resource allocation for the PUSCH transmission.

In some other examples, the FDRA field (e.g., the MSB of the FDRA field) may indicate the resource allocation type 1 for the PUSCH transmission. A PUSCH transmission with resource allocation type 1 can support frequency hopping. Accordingly, in such an example,

$$⌈ {log}_{2} ( {N}_{RB}^{UL , BWP} ( {N}_{RB}^{UL , BWP} + 1 ) / 2 ) ⌉ LSBs$$

of the FDRA field may indicate at least one of: a frequency offset or a frequency resource allocation.

For example, the BS may configure a frequency hopping for the PUSCH transmission with the waveform. In some embodiments, configure a frequency hopping for the PUSCH transmission with the waveform may refer to configuring a frequency hopping for a configured PUSCH repetition type (e.g., PUSCH repetition type A or PUSCH repetition type B). That is, configuring a frequency hopping for the PUSCH transmission may include one of the following cases: (1) configuring a dedicated RRC parameter which is used to configure frequency hopping for PUSCH repetition type A (e.g., a parameter frequencyHopping as specified in 3GPP standard documents) to the UE when PUSCH repetition type A (e.g., a parameter pusch-RepTypeA as specified in 3GPP standard documents) is configured for the PUSCH transmission; or (2) configuring another dedicated RRC parameter which is used to configure frequency hopping for PUSCH repetition type B (e.g., a parameter frequencyHoppingForDCI-Format0-1 as specified in 3GPP standard documents) to the UE when PUSCH repetition type B (e.g., a parameter pusch-RepTypeB as specified in 3GPP standard documents) is configured for the PUSCH transmission.

In the case that the frequency hopping is configured for the PUSCH transmission by the BS, whether the frequency hopping is enabled may be indicated by a frequency hopping flag field (illustrated below) in the DCI, and the frequency hopping being enabled or not may impact the

$$⌈ {log}_{2} ( {N}_{RB}^{UL , BWP} ( {N}_{RB}^{UL , BWP} + 1 ) / 2 ) ⌉ LSBs$$

of the FDRA field.

In an example, the FDRA field (e.g., the MSB of the FDRA field) indicates the resource allocation type 1 and the frequency hopping is enabled for the waveform. Then

$$⌈ {log}_{2} ( {N}_{RB}^{UL , BWP} ( {N}_{RB}^{UL , BWP} + 1 ) / 2 ) ⌉ LSBs$$

of the FDRA field may be used to indicate a frequency offset and a frequency resource allocation for the PUSCH transmission, wherein N_{UL_hop} MSBs of the

$$⌈ {log}_{2} ( {N}_{RB}^{UL , BWP} ( {N}_{RB}^{UL , BWP} + 1 ) / 2 ) ⌉ LSBs$$

are used to indicate a frequency offset and

$$⌈ {log}_{2} ( {N}_{RB}^{UL , BWP} ( {N}_{RB}^{UL , BWP} + 1 ) / 2 ) ⌉ - {N}_{UL \_ hop} LSBs$$

of the

$$⌈ {log}_{2} ( {N}_{RB}^{UL , BWP} ( {N}_{RB}^{UL , BWP} + 1 ) / 2 ) ⌉ LSBs$$

are used to indicate a frequency resource allocation for the PUSCH transmission, wherein N_{UL_hop} is determined according to a number of offset(s) included in a frequency hopping offset list (e.g., a parameter frequencyHoppingOffsetLists as specified in 3GPP standard documents).

In another example, the FDRA field (e.g., the MSB of the FDRA field) indicates the resource allocation type 1 for the PUSCH transmission and the frequency hopping may be disabled for the waveform, and

$$⌈ {log}_{2} ( {N}_{RB}^{UL , BWP} ( {N}_{RB}^{UL , BWP} + 1 ) / 2 ) ⌉ LSBs$$

of the FDRA field are used to indicate a frequency resource allocation for the PUSCH transmission.

In some other cases, the first resource allocation type configured for the CP-OFDM waveform and the second resource allocation type configured for the DFT-s-OFDM waveform cannot be resource allocation type 0 at the same time.

In another embodiment of the present disclosure, before transmitting the DCI, the BS may transmit a parameter configured to indicate a resource allocation type for different waveforms. For example, the BS may transmit a parameter (e.g., resourceAllocation) configuring a resource allocation type for both the CP-OFDM waveform and DFT-s-OFDM waveform.

In some cases, only resource allocation type 1 can be configured when dynamic waveform switching is enabled. Accordingly, in such cases, the resource allocation type for CP-OFDM waveform and DFT-s-OFDM waveform is resource allocation type 1. The BS may determine a bit width of the FDRA field to be

$$⌈ {log}_{2} ( {N}_{RB}^{UL , BWP} ( {N}_{RB}^{UL , BWP} + 1 ) / 2 ) ⌉ bits ,$$

wherein

$${N}_{RB}^{UL , BWP}$$

is a size of the active BWP. In such cases, regardless of which waveform is indicated by the DCI, all

$$⌈ {log}_{2} ( {N}_{RB}^{UL , BWP} ( {N}_{RB}^{UL , BWP} + 1 ) / 2 ) ⌉ bits$$

may be used to indicate the frequency domain resource allocation for the UE.

In some other cases, the resource allocation type for CP-OFDM waveform and DFT-s-OFDM waveform may be resource allocation type 0, resource allocation type 1 or dynamic resource allocation type. In such cases, the bit width of the FDRA field may be the same as that determined based on a corresponding RRC configuration as specified in 3GPP standard documents, e.g., in 3GPP standard documents in Rel-15). However, the interpretation of the FDRA field may be different in some embodiments.

For example, in the case that the resource allocation type for CP-OFDM waveform and DFT-s-OFDM waveform is resource allocation type 0, the bit width of the FDRA field is N_{RBG}, wherein N_{RBG} is a size of a resource block group as specified in TS 38.214.

However, since PUSCH transmission with DFT-s-OFDM waveform can only support resource allocation type 1. Thus, if DCI indicates DFT-s-OFDM waveform for the PUSCH transmission, the FDRA field may be interpreted based on resource allocation type 1.

Specifically, it is assumed that the bit width of the FDRA field determined for the DFT-s-OFDM waveform (i.e., determined based on resource allocation type 1) is N bits. In the case that the waveform indicated by the DCI is the DFT-s-OFDM waveform and M<=N_{RBG}. N LSBs of the FDRA field may be used for indicating a frequency resource allocation for the PUSCH transmission.

In the case that the waveform indicated by the DCI is the DFT-s-OFDM waveform and N>N_{RBG}, N_{RBG} bits of the FDRA field may be used for indicating a frequency resource allocation with a coarse granularity for the PUSCH transmission.

For example, the FDRA field includes a sequence of resource indication values (RIV), which corresponds to a starting resource block RBₛₜₐᵣₜ=0, K, 2·K, . . . ,

$$( {N}_{BWP}^{RB} - 1 ) \cdot K$$

in a BWP. In such an example, a length is determined in terms of virtually contiguously allocated resource blocks L_{RBs}=K, 2·K, . . . ,

$${N}_{BWP}^{RB} \cdot K ,$$

wherein K is the maximum value from set {1, 2, 4, 8} which satisfies K≤└N/N_{RBG}┘.

In some other cases, only dynamic resource allocation type can be configured when dynamic waveform switching is enabled. Accordingly, in such cases, the resource allocation type configured for the CP-OFDM waveform and the DFT-s-OFDM waveform is a dynamic resource allocation type. The bit width and the interpretation of FDRA field in such cases may be the same as those specified in 3GPP standard documents e.g., the bit width of FDRA field may be

$$max ( ⌈ {log}_{2} ( {N}_{RB}^{UL , BWP} ( {N}_{RB}^{UL , BWP} + 1 ) / 2 ) ⌉ , {N}_{RBG} ) + 1$$

in 3GPP standard documents in Rel-15.

In some other embodiments of the present disclosure, the one or more fields may include a frequency hopping flag field.

In such embodiments, in the case that the frequency hopping is not configured for both the DFT-s-OFDM waveform and the CP-OFDM waveform in an active BWP, a bit width of the frequency hopping flag field is 0 bit.

In the case that the frequency hopping is configured for at least one of the CP-OFDM waveform and DFT-s-OFDM waveform in the active BWP, a bit width of the frequency hopping flag field is 1 bit.

In the case that a frequency hopping is not configured for the waveform indicated by the DCI and the bit width of the frequency hopping flag field is larger than 0 bit (e.g., 1 bit as stated above), the BS may transmit arbitrary values in this field because this field does not make any sense for the UE.

In the case that the waveform indicated by the DCI is the CP-OFDM waveform and resource allocation type 0 is configured for the PUSCH transmission or indicated by the DCI for the PUSCH transmission and the bit width of the frequency hopping flag field is larger than 0 bit (e.g., 1 bit as stated above), the BS may transmit any values in this field because this field does not make any sense for the UE.

In some other embodiments of the present disclosure, the one or more fields may include a SRS resource indicator field.

In such embodiments, the BS may determine that a bit width for the SRS resource indicator field is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

for a non-codebook based PUSCH transmission, wherein N_{SRS} is a number of SRS resource in a SRS resource set configured for the PUSCH transmission (the SRS resource set is indicated by SRS resource set indicator field if present, otherwise the SRS resource set is configured by higher layer parameter srs-ResourceSetToAddModList as in 3GPP standard documents and associated with the higher layer parameter usage of value ‘nonCodeBook’)), and Lₘₐₓ is a maximum transmission layer configured to the UE for a serving cell. Specifically, Lₘₐₓ may be configured by maxMIMO-Layers as in 3GPP standard documents if UE supports operation with maxMIMO-Layers and the higher layer parameter maxMIMO-Layers is configured. Otherwise, Lₘₐₓ is given by the maximum number of layers for PUSCH supported by the UE for the serving cell for non-codebook based operation. For example, Lₘₐₓ is a maximum transmission layer supported by CP-OFDM waveform for dynamically switching between the CP-OFDM waveform and a DFT-s-OFDM waveform.

Then, in the case that the waveform indicated by the DCI is the DFT-s-OFDM waveform, since PUSCH transmission with DFT-s-OFDM can only support one layer,

$$⌈ {log}_{2} ( {\sum }_{k = 1}^{min ( 1 , {N}_{SRS} )} ( \begin{matrix}{N}_{SRS} \\ k\end{matrix} ) ) ⌉ LSBs$$

of the SRS resource indicator field are used for indicating SRS resource(s) in the SRS resource set for the non-codebook based PUSCH transmission.

In some other embodiments of the present disclosure, the one or more fields may include a second SRS resource indicator field.

In such embodiments, the BS may determine that a bit width for the second SRS resource indicator field is

$$⌈ {log}_{2} ( {max}_{k ∈ \{ 1 , 2 , ... , min \{ {L}_{max} , {N}_{SRS} \} \}} ( \begin{matrix}{N}_{SRS} \\ k\end{matrix} ) ) ⌉$$

for a non-codebook based PUSCH transmission, wherein N_{SRS} is a number of SRS resource in another SRS resource set configured for the PUSCH transmission (the another SRS resource set is the second SRS resource set configured by higher layer parameter srs-ResourceSetToAddModList as in 3GPP standard documents and associated with the higher layer parameter usage of value ‘nonCodeBook’) and Lₘₐₓ is a maximum transmission layer configured the UE for a serving cell. Specifically, Lₘₐₓ may be configured by maxMIMO-Layers as in 3GPP standard documents if UE supports operation with maxMIMO-Lavers and the higher layer parameter maxMIMO-Layers is configured. Otherwise, Lₘₐₓ is given by the maximum number of layers for PUSCH supported by the UE for the serving cell for non-codebook based operation. For example, Lₘₐₓ is a maximum transmission layer supported by CP-OFDM waveform for dynamically switching between the CP-OFDM waveform and a DFT-s-OFDM waveform.

Then, in the case that the waveform is the DFT-s-OFDM waveform, since PUSCH transmission with DFT-s-OFDM can only support one layer,

$$⌈ {log}_{2} ( {max}_{k ∈ \{ 1 , 2 , ... , min \{ 1 , {N}_{SRS} \} \}} ( \begin{matrix}{N}_{SRS} \\ k\end{matrix} ) ) ⌉ LSBs$$

are used for indicating SRS resource(s) in the another SRS resource set for the PUSCH transmission.

In some other embodiments of the present disclosure, the one or more fields include a precoding information and number of layers field. In some embodiments of the present disclosure, the precoding information and number of layers field herein may refer to a first precoding information and number of layers field as specified in 3GPP standard documents or a second precoding information and number of layers field as specified in 3GPP standard documents.

The BS may determine a bit width of the precoding information and number of layers field to be max{mₐ,m_{b}}, mₐ is a bit width of a precoding information and number of layers field which is derived (or determined) according to configurations for a DFT-s-OFDM waveform as specified in 3GPP standard documents; m_{b} is a bit width of a precoding information and number of layers field which is derived (or determined) according to configurations for a CP-OFDM waveform as specified in 3GPP standard documents. In some other embodiments of the present application, mₐ is a bit width of a precoding information and number of layers field which is derived (or determined) according to configurations for a CP-OFDM waveform as specified in 3GPP standard documents and my is a bit width of a precoding information and number of layers field which is derived (or determined) according to configurations for a DFT-s-OFDM waveform as specified in 3GPP standard documents.

In the case that the waveform indicated by the DCI corresponds to a smaller value of mₐ and my, Ima-mal MSBs of the precoding information and number of layers field are padded with zeros, and the remaining bits of the precoding information and number of layers field are used to indicate the transmission layer for a codebook based PUSCH transmission and to indicate the precoder matrix for the PUSCH transmission.

In some other embodiments of the present disclosure, the one or more fields include an antenna port field.

The BS may determine a bit width of the antenna port field to be max{xₐ, x_{b}}. xₐ is a bit width of an antenna port field determined according to DMRS configuration for a DFT-s-OFDM waveform as specified in 3GPP standard documents. In some embodiments, xₐ may also be determined based on a rank of the PUSCH transmission (e.g., a transmission layer of the PUSCH transmission) indicated by the DCI. x_{b} is a bit width of an antenna port field determined according to DMRS configuration for a CP-OFDM waveform as specified in 3GPP standard documents. In some embodiments, x_{b} may also be determined based on a rank of the PUSCH transmission (e.g., a transmission layer of the PUSCH transmission) indicated by the DCI. In some other embodiments of the present application, xₐ is a bit width of an antenna port field determined according to DMRS configuration for a CP-OFDM waveform as specified in 3GPP standard documents and x_{b} is a bit width of an antenna port field determined according to DMRS configuration for a DFT-s-OFDM waveform as specified in 3GPP standard documents.

In the case that the waveform indicated by the DCI corresponds to a smaller value of xₐ and x_{b}, |xₐ−x_{b}| MSBs of the antenna port field are padded with zeros, and the remaining bits of the antenna port field are used to indicate the DMRS port of the PUSCH transmission.

In some other embodiments of the present disclosure, the one or more fields include a PTRS-DMRS association field. To support dynamic switching between DFT-s-OFDM waveform and CP-OFDM waveform, the BS may determine a bit width of the PTRS-DMRS association field to be 2 bits in the case that a maximum layer configured for the PUSCH transmission is larger than 1.

In some embodiment, in the case that the waveform indicated by the DCI is the DFT-s-OFDM waveform and the PTRS-DMRS association field is more than 0 bit (i.e., 2 bits), the BS may transmit arbitrary values in this field because this field does not make any sense for the UE.

In some other embodiments of the present disclosure, the one or more fields include a second PTRS-DMRS association field. The UE may determine a bit width of the second PTRS-DMRS association field to be 2 bits in the case that a maximum layer configured for the PUSCH transmission is larger than 2. In the case that the waveform indicated by the DCI is the DFT-s-OFDM waveform and the second PTRS-DMRS association field is more than 0 bit (i.e., 2 bits), the BS may transmit arbitrary values in this field because this field does not make any sense for the UE.

In some other embodiments of the present disclosure, the one or more fields include a beta_offset indicator field.

In the case that a beta_offset parameter is configured to be “semiStatic” for both the DFT-s-OFDM waveform and the CP-OFDM waveform, the BS may determine a bit width of the beta_offset indicator field to be 0 bit.

In another example, in the case that a beta_offset parameter is configured to be “dynamic” for at least one of the CP-OFDM waveform or the DFT-s-OFDM waveform in an active BWP, the BS may determine a bit width of the beta_offset indicator field to be 2 bits.

In yet another example, in the case that a beta_offset parameter is configured to be “semiStatic” for the waveform indicated by the DCI and the bit width of the beta_offset indicator field is larger than 0 bit, the BS may transmit arbitrary values in this field because this field does not make any sense for the UE.

In some other embodiments of the present disclosure, the one or more fields include a DMRS sequence initialization field. To support dynamic switching between DFT-s-OFDM waveform and CP-OFDM waveform, the BS may determine a bit width of the DMRS sequence initialization field to be 1 bit.

Then, in the case that the waveform indicated by the DCI is the DFT-s-OFDM waveform, the BS may transmit arbitrary values in this field because this field does not make any sense for the UE.

According to some other embodiments of the present disclosure, for each field of the one or more fields, the BS may determine a bit width of each field based on configurations corresponding to the waveform indicated by the DCI. The BS may also determine a total bit width of the one or more fields to be max{Nₐ,N_{b}}, wherein Nₐ is a total bit width of the one or more fields determined according to configurations for a PUSCH transmission with the DFT-s-OFDM waveform and N_{b} is a total bit width of the one or more fields determined according to configurations for a PUSCH transmission with the CP-OFDM waveform. In some other embodiments of the present application, Nₐ is a total bit width of the one or more fields determined according to configurations for a PUSCH transmission with the CP-OFDM waveform and N_{b} is a total bit width of the one or more fields determined according to configurations for a PUSCH transmission with the DFT-s-OFDM waveform.

In such embodiments, in the case that the waveform indicated by the DCI corresponds to a smaller value of Nₐ and N_{b}, |Nₐ−N_{b}| zeros are padded before or after the one or more fields.

After determining a bit width of each field of the one or more fields. In step 303, the BS may transmit the DCI to the UE. The DCI may indicate a waveform of the PUSCH transmission scheduled or activated by the DCI.

Then, in step 305, the BS may receive the PUSCH transmission based on the DCI.

FIG. 4 illustrates a simplified block diagram of an exemplary apparatus 400 of determining DCI filed according to some embodiments of the present disclosure. In some embodiments, the apparatus 400 may be or include at least part of a UE (e.g., UE 101a or UE 101b in FIG. 1). In some other embodiments, the apparatus 400 may be or include at least part of a BS (e.g., BS 102 in FIG. 1).

Referring to FIG. 4, the apparatus 400 may include at least one transmitter 402, at least one receiver 404, and at least one processor 406. The at least one transmitter 402 is coupled to the at least one processor 406, and the at least one receiver 404 is coupled to the at least one processor 406.

Although in this figure, elements such as the transmitter 402, the receiver 404, and the processor 406 are illustrated in the singular, the plural is contemplated unless a limitation to the singular is explicitly stated. In some embodiments of the present disclosure, the transmitter 402 and the receiver 404 may be combined to one device, such as a transceiver. In some embodiments of the present disclosure, the apparatus 400 may further include an input device, a memory, and/or other components. The transmitter 402, the receiver 404, and the processor 406 may be configured to perform any of the methods described herein (e.g., the method described with respect to FIGS. 2 and 3).

According to some embodiments of the present disclosure, the apparatus 400 may be a UE, and the transmitter 402, the receiver 404, and the processor 406 may be configured to perform operations of the method as described with respect to FIG. 2. For example, the receiver 404 may be configured to receive DCI scheduling or activating a PUSCH transmission, wherein the DCI also indicates a waveform of the PUSCH transmission scheduled or activated by the DCI. The processor 406 may be configured to determine a bit width for each field of one or more fields in the DCI. The transmitter 402 may be configured to transmit the PUSCH transmission based on the DCI.

According to some embodiments of the present disclosure, the apparatus 400 may be a BS, and the transmitter 402, the receiver 404, and the processor 406 may be configured to perform operations of the method as described with respect to FIG. 3. For example, a processor 406 may be configured to determine a bit width for each field of one or more fields in DCI for scheduling or activating a PUSCH transmission. The transmitter 402 may be configured to: transmit the DCI, wherein the DCI indicates a waveform of the PUSCH transmission scheduled or activated by the DCI. The receiver 404 may be configured to receive the PUSCH transmission based on the DCI.

In some embodiments of the present disclosure, the apparatus 400 may further include at least one non-transitory computer-readable medium. In some embodiments of the present disclosure, the non-transitory computer-readable medium may have stored thereon computer-executable instructions to cause the processor 406 to implement any of the methods as described above. For example, the computer-executable instructions, when executed, may cause the processor 406 to interact with the transmitter 402 and/or the receiver 404, so as to perform operations of the methods, e.g., as described with respect to FIGS. 2 and 3.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present disclosure provides an apparatus of determining DCI filed, including a processor and a memory. Computer programmable instructions for implementing a method of determining DCI filed are stored in the memory, and the processor is configured to perform the computer programmable instructions to implement the method of determining DCI filed. The method of determining DCI filed may be any method as described in the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method of determining DCI filed according to any embodiment of the present disclosure.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
receive downlink control information (DCI) scheduling or activating a physical uplink shared channel (PUSCH) transmission, wherein the DCI also indicates a waveform of the PUSCH transmission scheduled or activated by the DCI;
determine a bit width for each field of one or more fields in the DCI; and
transmit the PUSCH transmission based on the DCI.

2. The UE of claim 1, wherein the PUSCH transmission is one of:
a dynamic PUSCH transmission scheduled by the DCI;
a configured grant (CG) type 2 PUSCH transmission activated by the DCI; or
a CG PUSCH retransmission scheduled by the DCI.

3. The UE of claim 1, wherein the bit width for each field of the one or more fields is determined to be a maximum bit width of bit widths determined based on radio resource control (RRC) configurations for different waveforms of PUSCH transmissions.

4. The UE of claim 3, wherein the one or more fields comprise a frequency hopping flag field, and:
when frequency hopping is not configured for both a discrete Fourier transform-spread orthogonal frequency division multiplexing (DFT-s-OFDM) waveform and a cyclic prefix orthogonal frequency division multiplexing (CP-OFDM) waveform in an active bandwidth part (BWP), a bit width of the frequency hopping flag field is 0 bit;
when the frequency hopping is configured for at least one of the CP-OFDM waveform and the DFT-s-OFDM waveform in the active BWP, a bit width of the frequency hopping flag field is 1 bit.

5. The UE of claim 4, wherein:
when the frequency hopping is not configured for the waveform indicated by the DCI and the bit width of the frequency hopping flag field is larger than 0 bit, indicated by the DCI, the at least one processor is further configured to cause the UE to ignore the frequency hopping flag field;
when the waveform indicated by the DCI is the CP-OFDM waveform and resource allocation type 0 is configured for the PUSCH transmission or indicated by the DCI for the PUSCH transmission, and the bit width of the frequency hopping flag field is larger than 0 bit, the at least one processor is further configured to cause the UE to ignore the frequency hopping flag field.

6. The UE of claim 3, wherein the one or more fields comprise a sounding reference signal (SRS) resource indicator field, and wherein the at least one processor is further configured to cause the UE to: determine a bit width for the SRS resource indicator field to be
$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$
for a non-codebook based PUSCH transmission, wherein N_{SRS} is a number of SRS resource in a SRS resource set configured for the PUSCH transmission and Lₘₐₓ is a maximum transmission layer configured to the UE for a serving cell;
when the waveform indicated by the DCI is the DFT-s-OFDM waveform,
$$⌈ {log}_{2} ( {\sum }_{k = 1}^{min ( 1 , {N}_{SRS} )} ( \begin{matrix}{N}_{SRS} \\ k\end{matrix} ) ) ⌉$$
least significant bits (LSBs) are used for indicating SRS resources in the SRS resource set for the non-codebook based PUSCH transmission.

7. The UE of claim 3, wherein the one or more fields comprise a precoding information and number of layers field, and wherein the at least one processor is further configured to cause the UE to: determine a bit width of the precoding information and number of layers field to be max{mₐ,m_{b}}, wherein mₐ is a bit width of precoding information and number of layers field determined according to configurations for a discrete Fourier transform-spread orthogonal frequency division multiplexing (DFT-s-OFDM) waveform and m_{b} is a bit width of precoding information and number of layers field determined according to configurations for a cyclic prefix orthogonal frequency division multiplexing (CP-OFDM) waveform; and
when the waveform indicated by the DCI corresponds to a smaller value of mₐ and m_{b}, |mₐ−m_{b}| most significant bits (MSB)s of the precoding information and number of layers field are padded with zeros.

8. The UE of claim 3, wherein the one or more fields comprise an antenna port field, and wherein the at least one processor is further configured to cause the UE to: determine a bit width of the antenna port field to be max{xₐ, x_{b}}, wherein xₐ is a bit width of an antenna port field determined according to demodulation reference signal (DMRS) configuration for a discrete Fourier transform-spread orthogonal frequency division multiplexing (DFT-s-OFDM) waveform and x_{b} is a bit width of an antenna port field determined according to DMRS configuration for a cyclic prefix orthogonal frequency division multiplexing (CP-OFDM) waveform; and
when the waveform indicated by the DCI corresponds to a smaller value of xₐ and x_{b}, |xₐ−x_{b}| most significant bits (MSB)s of the antenna port field are padded with zeros.

9. The UE of claim 3, wherein the one or more fields comprise a phase tracking reference signal (PTRS)-demodulation reference signal (DMRS) association field, and wherein the at least one processor is further configured to cause the UE to: determine a bit width of the PTRS-DMRS association field to be 2 bits in the case that a maximum layer configured for the PUSCH transmission is larger than 1; and
when the waveform indicated by the DCI is a discrete Fourier transform-spread orthogonal frequency division multiplexing (DFT-s-OFDM) waveform and the bit width of the PTRS-DMRS association field is larger than 0 bit, the at least processor is further configured to cause the UE to ignore the PTRS-DMRS association field.

10. The UE of claim 3, wherein the one or more fields comprise a beta_offset indicator field, and:
when a beta_offset parameter is configured to be “semiStatic” for both a discrete Fourier transform-spread orthogonal frequency division multiplexing (DFT-s-OFDM) waveform and a cyclic prefix orthogonal frequency division multiplexing (CP-OFDM) waveform, the at least one processor is further configured to cause the UE to determine a bit width of the beta_offset indicator field to be 0 bit;
when a beta_offset parameter is configured to be “dynamic” for at least one of the CP-OFDM waveform or the DFT-s-OFDM waveform in an active bandwidth part (BWP), the at least one processor is further configured to cause the UE to determine a bit width of the beta_offset indicator field to be 2 bits; and
when a beta_offset parameter is configured to be “semiStatic” for the waveform indicated by the DCI and the bit width of the beta_offset indicator field is larger than 0 bit, the at least processor is further configured to cause the UE to ignore the beta_offset indicator field.

11. The UE of claim 3, wherein the one or more fields comprise a demodulation reference signal (DMRS) sequence initialization field, and wherein the at least one processor is further configured to cause the UE to determine a bit width of the DMRS sequence initialization field to be 1 bit; and
when the waveform indicated by the DCI is a discrete Fourier transform-spread orthogonal frequency division multiplexing (DFT-s-OFDM) waveform, the at least one processor is further configured to cause the UE to ignore the DMRS sequence initialization field.

12. The UE of claim 1, wherein the at least one processor is further configured to cause the UE to: determine a bit width of each field of one or more fields based on configurations corresponding to the waveform indicated by the DCI, and wherein the at least one processor is further configured to cause the UE to: determine a total bit width of the one or more fields to be max{Nₐ,N_{b}}, wherein Nₐ is a total bit width of the one or more fields determined according to configurations for a PUSCH transmission with a discrete Fourier transform-spread orthogonal frequency division multiplexing (DFT-s-OFDM) waveform and N_{b} is a total bit width of the one or more fields determined according to configurations for a PUSCH transmission with a cyclic prefix orthogonal frequency division multiplexing (CP-OFDM) waveform; and
when the waveform indicated by the DCI corresponds to a smaller value of Nₐ and N_{b}, |Nₐ−N_{b}| zeros are padded before or after the one or more fields.

13. A base station (BS), comprising:
at least one memory; and
at least one processor coupled with the at one memory and configured to cause the BS to:
determine a bit width for each field of one or more fields in downlink control information (DCI) for scheduling or activating a physical uplink shared channel (PUSCH) transmission;
transmit the DCI, wherein the DCI indicates a waveform of the PUSCH transmission scheduled or activated by the DCI; and
receive the PUSCH transmission based on the DCI.

14. The BS of claim 13, wherein a bit width for each field of the one or one fields is determined to be a maximum bit width of bit widths determined based on radio resource control (RRC) configurations for different waveforms of PUSCH transmissions.

15. A method performed by a user equipment (UE), the method comprising:
receiving downlink control information (DCI) scheduling or activating a physical uplink shared channel (PUSCH) transmission, wherein the DCI also indicates a waveform of the PUSCH transmission scheduled or activated by the DCI;
determining a bit width for each field of one or more fields in the DCI; and
transmitting the PUSCH transmission based on the DCI.

16. The UE of claim 3, wherein the one or more fields comprise a second precoding information and number of layers field, and wherein the at least one processor is further configured to cause the UE to: determine a bit width of the second precoding information and number of layers field to be max{mₐ,m_{b}}, wherein mₐ is a bit width of the second precoding information and number of layers field determined according to configurations for a discrete Fourier transform-spread orthogonal frequency division multiplexing (DFT-s-OFDM) waveform and m_{b} is a bit width of the second precoding information and number of layers field determined according to configurations for a cyclic prefix orthogonal frequency division multiplexing (CP-OFDM) waveform; and
when the waveform indicated by the DCI corresponds to a smaller value of mₐ and m_{b}, |mₐ−m_{b}| most significant bits (MSB)s of the second precoding information and number of layers field are padded with zeros.

17. A processor for wireless communication, comprising:
at least one controller coupled with the at least one memory and configured to cause the processor to:
receive downlink control information (DCI) scheduling or activating a physical uplink shared channel (PUSCH) transmission, wherein the DCI also indicates a waveform of the PUSCH transmission scheduled or activated by the DCI;
determine a bit width for each field of one or more fields in the DCI; and
transmit the PUSCH transmission based on the DCI.

18. The processor of claim 17, wherein the bit width for each field of the one or more fields is determined to be a maximum bit width of bit widths determined based on radio resource control (RRC) configurations for different waveforms of PUSCH transmissions.

19. The processor of claim 17, wherein the one or more fields comprise a precoding information and number of layers field, and wherein the at least one controller is further configured to cause the processor to: determine a bit width of the precoding information and number of layers field to be max{mₐ,m_{b}}, wherein mₐ is a bit width of precoding information and number of layers field determined according to configurations for a discrete Fourier transform-spread orthogonal frequency division multiplexing (DFT-s-OFDM) waveform and m_{b} is a bit width of precoding information and number of layers field determined according to configurations for a cyclic prefix orthogonal frequency division multiplexing (CP-OFDM) waveform; and
when the waveform indicated by the DCI corresponds to a smaller value of mₐ and m_{b}, |mₐ−m_{b}| most significant bits (MSB)s of the precoding information and number of layers field are padded with zeros.

20. The processor of claim 17, wherein the one or more fields comprise an antenna port field, and wherein the at least one controller is further configured to cause the processor to: determine a bit width of the antenna port field to be max{xₐ, x_{b}}, wherein xₐ is a bit width of an antenna port field determined according to demodulation reference signal (DMRS) configuration for a discrete Fourier transform-spread orthogonal frequency division multiplexing (DFT-s-OFDM) waveform and x_{b} is a bit width of an antenna port field determined according to DMRS configuration for a cyclic prefix orthogonal frequency division multiplexing (CP-OFDM) waveform; and
when the waveform indicated by the DCI corresponds to a smaller value of xₐ and x_{b}, |xₐ−x_{b}| most significant bits (MSB)s of the antenna port field are padded with zeros.
